(19) United States
(12) Patent Application Publication
(10) Pub. No.: US 2007/0014024 A1
(43) Pub. Date: Jan. 18, 2007

(54) Imaging optical system and image taking apparatus

(75) Inventor: Mitsuaki Shimo, Osaka-shi (JP)

Correspondence Address: SIDLEY AUSTIN LLP, 717 NORTH HARWOOD, SUITE 3400, DALLAS, TX, 75201, US

(73) Assignee: KONICA MINOLTA OPTO, INC.

(21) Appl. No.: 11/481,457

(22) Filed: Jul. 6, 2006

(30) Foreign Application Priority Data
Jul. 6, 2005 (JP) 2005-197526

(51) Int. Cl. G02B 27/14

(52) U.S. Cl. 359/630; 359/884

(57) ABSTRACT

To provide an imaging optical system which is compact (thin) and can provide high performance (high resolution, high aberration correcting ability or the like).

In the imaging optical system OS of the present invention, at least three or more prism elements (for example, prisms PR1 to PR3) have a positive power, and an emission surface of one of the prism elements and an incident surface of at least one of the residual prism elements are arranged so as to be opposed to each other. The imaging optical system OS prevents a light ray which passes through the prisms from being intermediately imaged. Further, since an asymmetrical optical surface (for example, reflection surface) is provided, an optical path can be bent, so that the system can be made to be compact. Further, an asymmetrical optical surface or the like is adopted, so that asymmetry-specific aberration is corrected.

The present application claims priority to Japanese Patent Application No. 2005-197526 filed on Jul. 6, 2005, the entire contents of which are hereby incorporated by reference.

### BACKGROUND OF THE INVENTION

1. Field of the Invention

The present invention relates to an imaging optical system to be mounted to an imaging device for capturing an object image using an imaging device or the like, and an image taking apparatus.

2. Description of the Related Art

In recent years, digital devices such as mobile telephones and personal digital assistant (PDA) incorporate digital cameras (imaging devices) for capturing images. Such digital devices are desired to be miniaturized from the viewpoint of portability, whereas images devices are desired to have high efficiency from the viewpoint of an improvement in image quality.

In the case where pixel of imaging devices is heightened as one of the high efficiency, it is accordingly necessary to improve resolution or the like of optical systems (imaging optical systems) for imaging object images on imaging devices. For example, in an optical system (coaxial optical systems) which is called as a straight type optical system, the optical system itself is enlarged or the number of lenses composing the optical system is increased in order to heighten the resolution or the like. For this reason, in digital devices adopting such a coaxial optical system, it is difficult to fulfill both demands of miniaturization and improvement in performance (improvement in pixel). Differently from the coaxial optical system, therefore, the demand for optical systems which are small-sized and has high resolution or the like becomes enormously strong.

In order to fulfill the demand, various asymmetrical optical systems (for example, optical systems using prism elements having tilted reflection surfaces) which are different from the coaxial optical systems are proposed in recent years. For example, optical systems in Japanese Patent Application Laid-Open Nos. 10-11525 and 9-329747 include one prism element. The respective prism elements have four optical working surfaces (optical surfaces) composed of two transmission surfaces and two reflection surfaces. Since these optical systems have one prism element, the size of the optical systems can be reduced. However, since these optical systems having such a simple constitution that the number of the optical working surfaces is four which is comparatively small, it is difficult to improve resolution or the like.

In the optical system of Japanese Patent Application Laid-Open No. 9-329747, an on-axial light ray (first on-axial light ray) from an incident surface to the first reflection surface crosses an on-axial light ray(second on-axial light ray) from the second reflection surface to an emission surface approximately vertically to each other. Such crossing means that a space where the second on-axial light ray advances is secured between the incident surface and the first reflection surface. It is, therefore, hard to say that the optical system of Japanese Patent Application Laid-Open No. 9-329747 is sufficiently miniaturized (thinned).

An optical system of Japanese Patent Application Laid-Open No. 10-20196 includes two prism elements having totally four optical working surfaces composed of two transmission surfaces and two reflection surfaces (that is to say, totally eight optical working surfaces). For this reason, the number of the optical working surfaces is comparatively large, and thus the resolution or the like is easily improved. The two prism elements are, however, simply arranged along a normal line direction of an image surface. For this reason, in the optical system of Japanese Patent Application Laid-Open No. 10-20196, the length in the normal line direction of the image surface reflects directly an entire thickness of the two prism elements and a gap between the prism elements. It is, therefore, hard to say that the optical system of Japanese Patent Application Laid-Open No. 10-20196 is sufficiently miniaturized.

Further, an optical system of Japanese Patent Application Laid-Open No. 8-292368 includes three prism elements. For this reason, the number of optical working surfaces increases, and a light ray from an object can be reflected by reflection surfaces a plural number of times. In the optical system of Japanese Patent Application Laid-Open No. 8-292368, the resolution or the like can be easily improved. Since, however, the reflection of the light ray a plural number of times is repeated, an optical length is likely to be long excessively. For this reason, in the optical system of Japanese Patent Application Laid-Open No. 8-292368, although the resolution or the like is easily improved, the size of the optical system is likely to be easily large.

### SUMMARY OF THE INVENTION

It is a main object of the present invention to provide an optical system or the like which is small-sized (thin) and can achieve high performance (high resolution, high aberration correcting ability or the like).

The imaging optical system of the present invention has a plurality of prism elements through which a light ray advancing from an object to an imaging device passes. At least one of the prism elements has an asymmetrical optical surface, and at least one prism has a positive power. An emission surface of one of the prism elements and an incident surface of at least one of the residual prism elements are arranged so as to be opposed to each other. Particularly the imaging optical system of the present invention includes at least three or more prism elements, and the light ray which passes through the prism elements is not intermediately imaged.

The prism element is an element where at least one of optical working surfaces is a reflection surface.

The asymmetrical optical surface is a transmission surface which is asymmetrical with respect to advancing light ray, a reflection surface whose optical path bending angle is other than 90° or 180°, or a reflection surface having a power asymmetrical with respect to the advancing light ray. When the asymmetrical transmission surface is provided, an aberration caused by an asymmetrical chromatic aberration can be corrected. The asymmetrical reflection surface is different from rectangular prisms composed of planes which are used for coaxial optical systems. Since the optical path is bent at an angle other than 90° or 180°, the power to be applied to reflected light ray differs in a horizontal direction and a vertical direction with respect to the bent surface. As a result, the asymmetry is destroyed. When the asymmetrical reflection surface is provided, the optical path can be bent freely, so that the optical path does not extend to one direction, and becomes compact unlike coaxial optical systems or the like.

When three or more prism elements are provided, the bending of the optical path is not limited to planar bending, and thus the optical path can be bent three-dimensionally, for example, can be twisted. Further, the imaging performance can be improved by the power of the asymmetrical reflection surface. The imaging optical system of the present invention can be, therefore, made to be compact and also thin, so that an aberration can be corrected sufficiently.

In order to realize the high performance, it is necessary to increase the optical working surfaces and the prism elements. However, when the number of the optical working surfaces is simply increased, the prism element becomes large and thus cannot be thinned. When the number of the prism element is increased simply, a space for the prism element is necessary, and thus the prism element cannot be thinned. In order to realize the high performance, therefore, at least three prism elements are necessary in the imaging optical system.

Since the optical path becomes longer than that of coaxial optical systems or the like, the high performance can be realized by utilizing the length. Further, manufacturing error sensitivity is suppressed by utilizing the length.

In general, however, when the optical length becomes longer with respect to a focal distance, an intermediate image should be formed. When such an intermediate image is formed, it is necessary to relay the intermediate image to the image surface. In such an optical system which provides the relay, a comparatively large curvature of the image surface occurs due to the influence of a positive power required for the relay. When such a curvature of the image surface occurs, the point of focus varies on the center position and on the peripheral position of the image surface. For this reason, a serious deterioration in performance occurs. Further, an optical working surface with a strong negative power is occasionally necessary for correcting the curvature of the image surface. In this case, a major coma aberration occurs due to the negative optical working surface. For this reason, the imaging optical system cannot be provided with high performance.

In the imaging optical system where the intermediate image is formed, since the influence of an error due to processing is amplified by the relay, the control of accuracy becomes tight after all, so that it is difficult to put the system into practical use.

Due to the above reasons, in order to realize the imaging optical system which has the high performance, is small and is easily put into practical use, therefore, it is desirable that an intermediate image is not formed on the optical path in the imaging optical system.

In the imaging optical system of the present invention, it is preferable that the prism element having the positive power fulfills the following conditional expression (1)
0.01<φp/φALL<10.0 (1)
however,
φp: the power of the prism element having the positive power
φALL: the power of the entire imaging optical system.

This conditional expression (1) defines the power of the prism element having the positive power (positive prism element). More specifically, the conditional expression (1) defines a range for realizing the thinning and the high performance of the imaging optical system based on the positive power of the prism element.

The prism element having the positive power causes an under curvature of the image surface. In order to sufficiently correct the under curvature of the image surface, the prism element or the like requires the optical working surfaces having a negative power (negative optical working surfaces). However, when the positive power is not suitable, for example, too strong, the negative power should be strengthened according to the strong positive power. Since the entire system requires the positive power, the negative optical working surface is arranged near the diaphragm where the height of the light ray is low. In this case, the serious coma aberration is caused by the comparatively strong negative optical working surface, and the imaging performance of the imaging optical system is notably deteriorated. Further, since an asymmetrical astigmatism notably occurs due to the asymmetrical imaging optical system, the imaging performance of the imaging optical system is deteriorated. Due to such a circumstance, it is a requirement of the high-performance imaging optical system where the power of the positive prism element is set suitably.

Due to the above reason, in the case where the positive power exceeds an upper limit value of the conditional expression (1), the positive power of the prism element becomes too strong, and thus the coma aberration and the astigmatism occur. For this reason, the performance of the imaging optical system is deteriorated. On the other hand, in the case where the positive power is lower than a lower limit value of the conditional expression (1), the power of the positive prism element becomes too weak, and thus a contribution of the power of the positive prism element to the entire system becomes small. For this reason, it is difficult to thin the imaging optical system. Therefore, within the range of the conditional expression (1), the present invention provides the compact imaging optical system where the occurrence of aberrations is suppressed (the performance is heightened).

In the imaging optical system of the present invention, at least one of the prism elements may have three surfaces including one incident surface for allowing the light ray to enter, one reflection surface for reflecting the light ray from the incident surface and one emission surface for allowing the light ray from the reflection surface to emit as the optical surfaces (optical working surfaces). Such a prism element having the simple constitution (having the small number of the optical surfaces) can greatly contribute to the miniaturization of the imaging optical system. Further, the simple constitution can contribute to the easy processing of the prism elements and also the reduction in the cost.

In another case, at least one of the prism elements has one incident surface for allowing the light ray to enter, at least two reflection surfaces for reflecting the light ray from the incident surface and one emission surface for allowing the light ray from the reflection surfaces to emit as the optical surfaces. This constitution can occasionally contribute to the miniaturization (thinning) of the imaging optical system sufficiently.

In the imaging optical system of the present invention, the incident surface where the light ray enters may reflect the light ray reflected by the reflection surface to the emission surface. When the light ray is folded by the reflection surface, the optical path in the prism elements can be made to be compact. When the optical surfaces fulfill both the transmitting and reflecting functions, asymmetrical aberrations can cancel each other because the two reflection surfaces are provided, and thus the aberration correcting effect is improved.

In the imaging optical system of the present invention, the reflection surface of the prism element may be asymmetrical. Since the asymmetrical reflection surface has a power, the optical path can be bent freely, and the imaging performance can be improved. When the reflection surface is arranged asymmetrically, the optical path can be bent efficiently, so that the prism element and then the size of the imaging optical system is reduced.

In the asymmetrical imaging optical system of the present invention, an asymmetry-specific aberration occurs. For example, astigmatism occurs on the axis. In order to correct the astigmatism, however, the curvature radiuses of the optical working surface in the horizontal direction and the vertical direction are varied. This situation is applied also to portions other than the on-axial portion (for example, peripheral portion). An asymmetrical surface whose curvature radiuses in the horizontal and vertical directions can be selected arbitrarily is suitable for realizing such an optical working surface. In order to correct the asymmetry-specific aberration, it is preferable that at least one asymmetrical optical working surface is provided. Further, the asymmetrical aberration cannot be sufficiently corrected only by an individual reflection surface. Since the emitted light ray from the asymmetrical reflection surface is not coaxial, when the light ray passes through the transmission surface, an asymmetrical chromatic aberration occurs. An asymmetrical transmission surface is necessary in order to eliminate this aberration. That is to say, a plurality of asymmetrical surfaces are necessary for sufficiently suppressing the asymmetrical aberration.

The larger number of the optical working surfaces are advantageous to the realization of the high performance. For this reason, the larger number of the prism elements are preferable. When the number of the prism elements is large, however, a space for arranging them is necessary, and thus this is disadvantageous to the thinning. In order to achieve both the high performance and the thinning, the imaging optical system including three prism elements is desirable. In such an imaging optical system, the length of optical path with respect to the focal distance can be suitably set, and the intermediate imaging can be avoided. A higher-performance optical system is, therefore, realized.

In the imaging optical system of the present invention, at least one of the prism elements may be formed by resin. With such a constitution, an asymmetrical surface, a free-form surface and the like can be formed easily. With use of the resin, another working portion (for example, an edge surface or the like) can be molded (integrally molded) simultaneously with the formation of the asymmetrical surface or the like. As a result, the cost of the material and the cost of the processing can be reduced. Due to the use of the resin, the weight can be reduced. The formation using the resin means that the resin material is used as a base material, and this includes the case where its surface is subject to a coating process in order to prevent reflection and improve surface hardness.

In general, the refractive index of the resin changes (optical transition) depending on the temperature change. For this reason, in the case where the resin is used for the prism elements of the imaging optical system, the image point possibly moves greatly due to the change in the refractive index based on the temperature change. Accordingly, the asymmetrical optical system has a problem such that an astigmatic difference is enlarged on the axis. Further, a fluctuation in various aberrations according to the change in the refractive index is large, thereby causing a deterioration in the performance.

As the resin of the prism elements in the imaging optical system of the present invention, therefore, for example, a resin disclosed in Japanese Patent Application Laid-Open No. 2005-55852 is desirable. In the resin material disclosed in this publication, the change in refractive index depending on the temperature is comparatively smaller than that of normal resin materials (particularly, the resin material whose change in refractive index depending on the temperature is small is called as athermal resin).

The athermal resin is obtained by dispersing particles with the maximum length of 30 nm or less (sub-material; for example, inorganic fine particles) into the resin material (base material). For example, a material obtained by dispersing niobium oxide (Nb2O5) into acrylic resin can be the athermal resin. When the prism element is formed by such athermal resin, since the change in refractive index depending on the temperature change becomes small, the fluctuation in the image point, the increase in the astigmatic difference and the fluctuation in various aberrations can be suppressed to be small.

In the examples of the resin material and the inorganic fine particles disclosed in Japanese Patent Application Laid-Open No. 2005-55852, symbols dnd/dt in the case where the refractive index nd is differentiated by the temperature t are shown. The publication shows an example where the resin material with the symbol dnd/dt (first property) is mixed with the inorganic fine particles with the symbol dnd/dt (second property) which is different from dnd/dt of the resin material. Like this example, in the case where the resin material and the inorganic fine particles whose symbols are different from each other are mixed (different properties), the respective properties (the property of the resin and the property of the inorganic fine particles) cancel each other. For this reason, the quantity of the inorganic fine particles to be dispersed in the resin may be small.

For example, when the property of the resin material (first property) is excessively canceled, the athermal resin has a new property. As one example of the new property, the linear coefficient of the expansion of the resin material, namely, the athermal resin becomes comparatively small.

In another example, a resin material and inorganic fine particles having the same symbols dnd/dt are mixed. In this example, when the absolute value of dnd/dt of the inorganic fine particles is smaller than that of dnd/dt of the resin material, the change in refractive index due to the temperature change becomes small even when they have the same symbol dnd/dt. As a result, the amount of the change in the image point position of the imaging optical system can be reduced in comparison with the case where the conventional resin material is used. It goes without saying that also in the case where the resin material and the inorganic fine particles with different symbols are mixed, the amount of the change in the image point position of the imaging optical system can be reduced in comparison with the conventional resin material is used.

In the case of the imaging optical system of the present invention, the comparatively large astigmatic difference is generated easily due to the asymmetrical optical system. In order to correct this astigmatic difference, the athermal resin should be used because conventional adjustment of power distribution has limitations. As understood from the above description, it is desirable for realizing the high-performance asymmetrical optical system capable of maintaining the astigmatic difference small that the athermal resin is used like the imaging optical system of the present invention.

According to the present invention, since the simple prism elements are used, the thin imaging optical system can be realized. Further, since the intermediate imaging is not carried out in the imaging optical system, the present invention provides the high-performance (for example, less performance due to the processing error) imaging optical system. Therefore, the high-performance thin imaging optical system is realized.

It goes without saying that an image taking apparatus, which includes the above-mentioned imaging optical system and imaging devices which receive a light ray from the imaging optical system, is compact and has high performance.

The invention itself, together with further objects and attendant advantages, will best be understood by reference to the following detailed description taken in conjunction with the accompanying drawings.

### BRIEF DESCRIPTION OF THE DRAWINGS

FIG. 1 is an optical sectional view of an image taking apparatus including an imaging optical system according to a first embodiment of the present invention;

FIG. 2 is an optical sectional view of the image taking apparatus including the imaging optical system according to a second embodiment of the present invention;

FIG. 3 is an explanatory diagram of right-hand XYZ coordinate;

FIGS. 4A to 4F are lateral aberration charts in a direction X in the image taking apparatus according to the first embodiment;

FIGS. 5A to 5F are lateral aberration charts in a direction Y in the image taking apparatus according to the first embodiment;

FIGS. 6A to 6F are lateral aberration charts in the direction X in the image taking apparatus according to the second embodiment;

FIGS. 7A to 7F are lateral aberration charts in the direction Y in the image taking apparatus according to the second embodiment;

FIG. 8 is an explanatory diagram of a local orthogonal coordinate in an image surface IS;

FIG. 9 is an optical sectional view of the image taking apparatus including the imaging optical system according to a third embodiment of the present invention;

FIGS. 10A to 10F are lateral aberration charts in the direction X in the image taking apparatus according to the third embodiment;

FIGS. 11A to 11F are lateral aberration charts in the direction Y in the image taking apparatus according to the third embodiment;

FIG. 12 is an optical sectional view of the image taking apparatus including the imaging optical system according to a fourth embodiment of the present invention;

FIGS. 13A to 13F are lateral aberration charts in the direction X in the image taking apparatus according to the fourth embodiment; and

FIGS. 14A to 14F are lateral aberration charts in the direction Y in the image taking apparatus according to the fourth embodiment.

In the following description, like parts are designated by like reference numbers throughout the several drawings.

### DETAILED DESCRIPTION OF THE PREFERRED EMBODIMENTS

As an optical system (imaging optical system) of the present invention, various types of optical systems are assumed. For example, such optical systems include an imaging optical system where only prism elements are combined, and an imaging optical system where optical elements such as a reflection mirror and a lens are added to the prism elements. Four examples of the various assumed imaging optical systems are, therefore, explained below. An unit including an imaging optical system and an imaging device which receives a light ray from the imaging optical system is expressed as an image taking apparatus. The imaging optical system may be expressed as an image forming optical system from the viewpoint that an optical image is formed on the imaging device, or may be expressed as a non-axial optical system from the viewpoint that an asymmetrical optical working surface is provided.

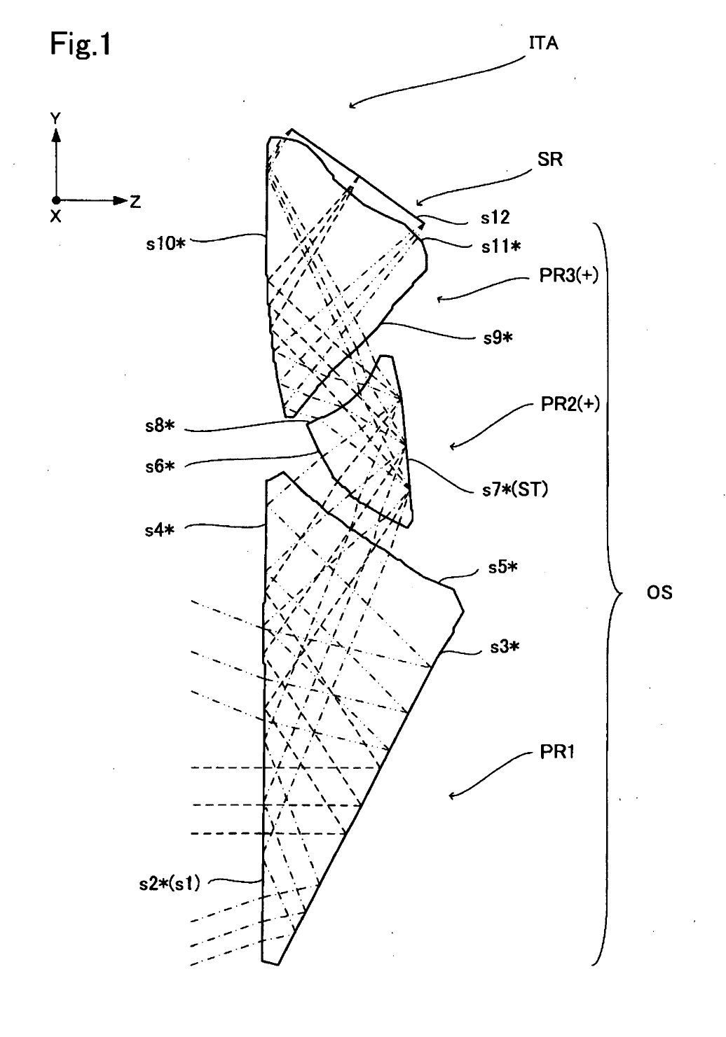

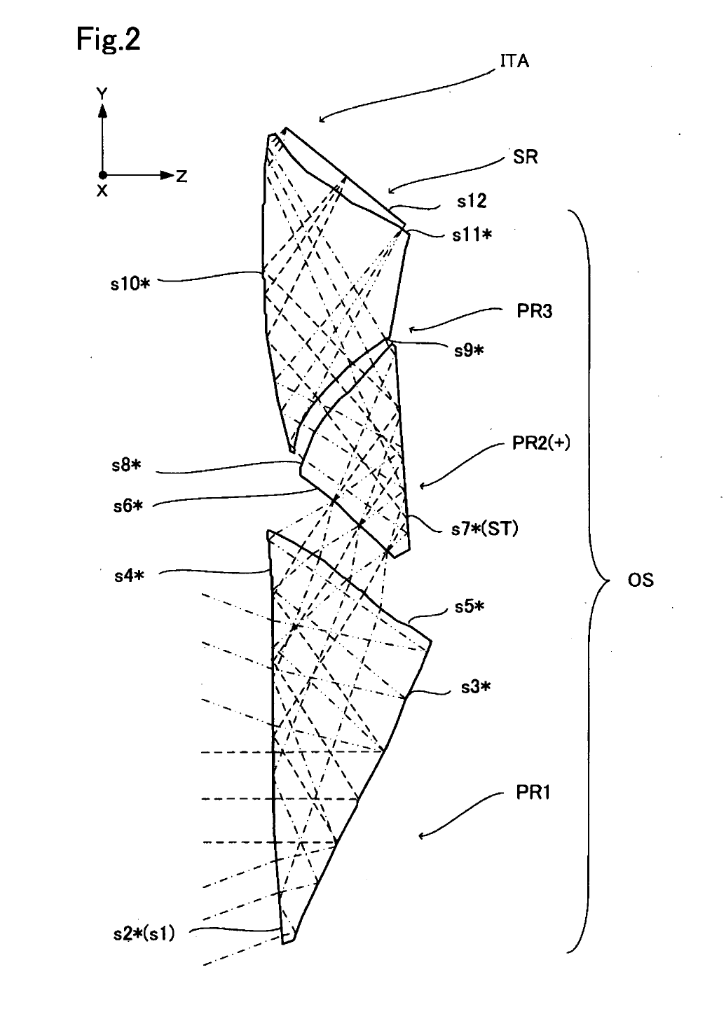

FIGS. 1 (first embodiment) and 2 (second embodiment) are optical sectional views illustrating an image taking apparatus ITA. As shown in FIGS. 1 and 2, the image taking apparatus ITA includes an imaging optical system OS (a first prism PR1 to a third prism PR3), and an imaging device SR. In order to express respective surfaces (si) on the prisms PR1 to PR3 and image surfaces (si) of an imaging device SR, they are designated by numerals according to the order of incidence of a light ray from an object to an imaging device (image surface) (ith: i=1, 2, 3, . . . ). Further, a free-form surface is designated by asterisk (*).

As shown in FIGS. 1 and 2, the imaging optical system OS includes the first prism PR1, the second prism PR2 and the third prism PR3. The first prism PR1 is a prism through which a light ray from an object firstly passes, and the second prism PR2 is a prism where an emitted light ray from the first prism PR1 sequentially enters. The third prism PR3 is a prism which allows the emitted light ray from the second prism PR2 to pass (transmit) therethrough and leads it to an image surface (imaging device SR).

The first prism PR1 has four optical working surfaces (s2 to s5). Due to a design using a global coordinate, the first surface s1 is a dummy surface (reference surface; surface for expressing respective surface vertex positions). For this reason, in FIGS. 1 and 2, even the surface where the light ray (light ray) from the object firstly enters is not described as a first surface s1 (described in parentheses).

A surface which firstly receives the light ray from the object and allows it to transmit, namely, an incident surface is described as a second surface s2 in FIGS. 1 and 2. A third surface s3 is a reflection surface which reflects the light ray transmitting (passing) through the second surface s2 towards a fourth surface s4.

A fourth surface s4 is a reflection surface which reflects the light ray (reflected light ray) reflected by the third surface s3 towards a fifth surface s5. As shown in FIGS. 1 and 2, the second surface s2 and the fourth surface s4 are TIR (Total Internal Reflection) surfaces having both transmitting and reflecting functions.

A fifth surface s5 is an emission surface (transmission surface) which allows the reflected light ray from the fourth surface s4 to emit (transmit) towards the second prism PR2. The fifth surface s5 and a sixth surface s6, mentioned later, establish an arrangement relationship where they are opposed to each other (opposed arrangement).

On the other hand, the second prism PR2 is a prism which leads the light ray passing through the first prism PR1 to the third prism PR3. The second prism PR2 has a positive power [converging power (+); the power is defined by an inverse of a focal distance]. The second prism PR2 has three optical working surfaces (s6 to s8).

The sixth surface s6 is an incident surface (transmission surface) which firstly receives the light ray from the first prism PR1 and allows it to transmit. A seventh surface s7 is a reflection surface which reflects the light ray (transmitted light ray) passing through the sixth surface s6 towards an eighth surface s8. The eighth surface s8 is an emission surface (transmission surface) which allows the light ray (reflected light ray) from the seventh surface s7 to emit (transmit) towards the third prism PR3.

On the seventh surface s7, optical diaphragm ST (for example, optical diaphragm having a circular diaphragm shape) is provided. Further, the eighth surface s8 and a ninth surface s9, mentioned later, are arranged so as to be opposed to each other.

The third prism PR3 is a prism which leads the light ray passing through the second prism PR2 to the imaging device SR (image surface s12). The third prism PR3 has a positive power (+) in the first embodiment. The third prism PR3 has three optical working surfaces (s9 to s11).

The ninth surface s9 is an incident surface (transmission surface) which firstly receives the light ray from the second prism PR2 and allows it to transmit through. A tenth surface s10 is a reflection surface which reflects the light ray passing through the ninth surface s9 (transmitted light ray) towards an eleventh surface s11. Further, the eleventh surface s11 is an emission surface (transmission surface) which allows the light ray from the tenth surface s10 (reflected light ray) to emit (transmit) towards the imaging device SR (image surface s12).

The imaging surface s12 of the imaging device SR receives the light ray (light image) passing through the prisms PR1 to PR3, and the imaging device SR converts the light ray into an electric signal (electronic data). Examples of the imaging device SR are an area sensor and a CMOS (Complementary Metal Oxide Semiconductor) sensor of CCD (Charge Coupled Device).

In the imaging device having the image taking apparatus (ITA) (for example, digital camera), a processing section which gives various processes to the electronic data converted by the imaging device SR, a storage section which stores the electronic data, and the like are provided.

Construction data in the image taking apparatus (ITA) of the first and second embodiments are explained with reference to tables 1 to 8.

TABLE 1
FIRST EMBODIMENT

| si | i | ri[mm] | | i | Ni | νi | Optical Element |
|---|---|---|---|---|---|---|---|
| s1 | 1 | ∞ | Reference | | Air | Air | PR1 |
| | | | surface | | | | |
| s2* | 2 | ∞ | Incident | 1 | 1.53 | 55.7 | |
| | | | surface | | | | |
| s3* | 3 | ∞ | Reflection | 2 | 1.53 | 55.7 | |
| | | | surface | | | | |
| s4* | 4 | ∞ | Reflection | 3 | 1.53 | 55.7 | |
| | | | surface | | | | |
| s5* | 5 | ∞ | Emission | | Air | Air | PR2(+) |
| | | | surface | | | | |
| s6* | 6 | ∞ | Inicident | 4 | 1.53 | 55.7 | ST |
| | | | surface | | | | |
| s7* | 7 | ∞ | Reflection | 5 | 1.53 | 55.7 | |
| | | | surface | | | | |
| s8* | 8 | ∞ | Emission | | Air | Air | PR3(+) |
| | | | surface | | | | |
| s9* | 9 | ∞ | Incident | 6 | 1.53 | 55.7 | |
| | | | surface | | | | |
| s10* | 10 | ∞ | Reflection | 7 | 1.53 | 55.7 | |
| | | | surface | | | | |
| s11* | 11 | ∞ | Emission | | | | |
| | | | surface | | | | |
| s12 | 12 | ∞ | Image | | Air | Air | SR |
| | | | surface | | | | |

TABLE 2
SECOND EMBODIMENT

| si | i | ri[mm] | | i | Ni | νi | Optical Element |
|---|---|---|---|---|---|---|---|
| s1 | 1 | ∞ | Reference | | Air | Air | PR1 |
| | | | surface | | | | |
| s2* | 2 | ∞ | Incident | 1 | 1.65 | 58.5 | |
| | | | surface | | | | |
| s3* | 3 | ∞ | Reflection | 2 | 1.65 | 58.5 | |
| | | | surface | | | | |
| s4* | 4 | ∞ | Reflection | 3 | 1.65 | 58.5 | |
| | | | surface | | | | |
| s5* | 5 | ∞ | Emission | | Air | Air | PR2(+) |
| | | | surface | | | | |
| s6* | 6 | ∞ | Incident | 4 | 1.49 | 70.4 | ST |
| | | | surface | | | | |
| s7* | 7 | ∞ | Reflection | 5 | 1.49 | 70.4 | |
| | | | surface | | | | |
| s8* | 8 | ∞ | Emission | | Air | Air | PR3 |
| | | | surface | | | | |
| s9* | 9 | ∞ | Incident | 6 | 1.70 | 30.1 | |
| | | | surface | | | | |
| s10* | 10 | ∞ | Reflection | 7 | 1.70 | 30.1 | |
| | | | surface | | | | |
| s11* | 11 | ∞ | Emission | | Air | Air | SR |
| | | | surface | | | | |
| s12 | 12 | ∞ | Image | | | | |
| | | | surface | | | | |

“si” in Tables 1 and 2 is the ith surface according to the incident order of the light rays counted from the object. “ri” is a curvature radius [unit: mm] on the respective surfaces (si). “Ni”•“ui” designates refractive index (Nd)•Abbe's number (vd) with respect to a line d (587.56 nm) of a medium positioned on the gap of the on-axis surface between the ith surface (si) and the i+1st surface (si+1).

TABLE 3
FIRST EMBODIMENT

| | Surface Vertex Coordinate [mm] | | | Rotational Angle [°] | | |
|---|---|---|---|---|---|---|
| si | X Coordinate | Y Coordinate | Z Coordinate | Rotation about X | Rotation about Y | Rotation about Z |
| s1 | 0.000 | 0.000 | 0.000 | 0.00 | 0.00 | 0.00 |
| s2* | 0.000 | 0.000 | 0.000 | 0.00 | 0.00 | 0.00 |
| s3* | 0.000 | 0.000 | 2.500 | −28.00 | 0.00 | 0.00 |
| s4* | 0.000 | 0.000 | 0.000 | 0.00 | 0.00 | 0.00 |
| s5* | 0.000 | 6.936 | 2.110 | 55.02 | 0.00 | 0.00 |
| s6* | 0.000 | 7.500 | 2.549 | 55.43 | 0.00 | 0.00 |
| s7* | 0.000 | 9.058 | 3.597 | 6.00 | 0.00 | 0.00 |
| s8* | 0.000 | 10.300 | 2.314 | −43.16 | 0.00 | 0.00 |
| s9* | 0.000 | 10.900 | 1.695 | −44.35 | 0.00 | 0.00 |
| s10* | 0.000 | 13.109 | 0.000 | 3.05 | 0.00 | 0.00 |
| s11* | 0.000 | 15.300 | 2.063 | 50.00 | 0.00 | 0.00 |
| s12 | 0.000 | 15.144 | 2.352 | 55.99 | 0.00 | 0.00 |

TABLE 4
Second EMBODIMENT

| | Surface Vertex Coordinate [mm] | | | Rotational Angle [°] | | |
|---|---|---|---|---|---|---|
| si | X Coordinate | Y Coordinate | Z Coordinate | Rotation about X | Rotation about Y | Rotation about Z |
| s1 | 0.000 | 0.000 | 0.000 | 0.00 | 0.00 | 0.00 |
| s2* | 0.000 | 0.000 | 0.000 | 0.00 | 0.00 | 0.00 |
| s3* | 0.000 | 0.000 | 2.500 | −28.00 | 0.00 | 0.00 |
| s4* | 0.000 | 0.000 | 0.000 | 0.00 | 0.00 | 0.00 |
| s5* | 0.000 | 6.350 | 1.850 | 55.54 | 0.00 | 0.00 |
| s6* | 0.000 | 7.664 | 2.516 | 52.49 | 0.00 | 0.00 |
| s7* | 0.000 | 9.629 | 3.815 | 2.19 | 0.00 | 0.00 |
| s8* | 0.000 | 11.549 | 2.297 | −39.42 | 0.00 | 0.00 |
| s9* | 0.000 | 11.600 | 1.600 | −36.41 | 0.00 | 0.00 |
| s10* | 0.000 | 13.344 | −0.189 | 3.31 | 0.00 | 0.00 |
| s11* | 0.000 | 16.976 | 1.895 | 28.95 | 0.00 | 0.00 |
| s12 | 0.000 | 17.430 | 2.130 | 52.31 | 0.00 | 0.00 |

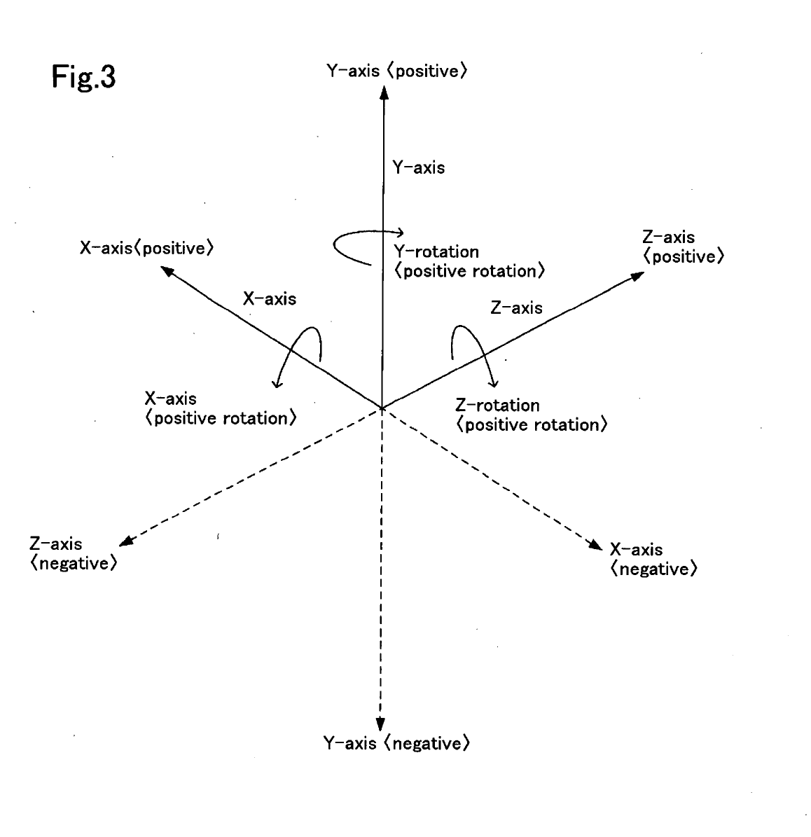

Tables 3 and 4 show “surface vertex coordinate” and “rotational angle” on the respective surfaces (si). The surface vertex coordinate (surface data; [unit: mm]) is expressed based on a right-hand orthogonal coordinate shown in FIG. 3 (X coordinate, Y coordinate and Z coordinate) [X coordinate (X axis); thumb, Y coordinate (Y axis); index finger, Z coordinate (Z axis); middle finger].

Concretely, the light ray which passes through the center of the object surface and the center of the image surface is defined as a base light ray, and an intersecting point between the base light ray and the first surface s1 is an original point (0,0,0). The Z axial direction is a direction where the base light ray passes through the original point from the center of the object surface towards the first surface s1, and this direction is <positive (positive direction)>. As a result, the X axial direction is a vertical direction with respect to a sheet surface of FIG. 1, and a direction facing a rear side of the sheet is <positive (positive direction)>. On the other hand, the Y axial direction is a parallel direction with respect to the sheet surface, and a direction facing the upper portion of the sheet surface is <positive (positive direction)>.

Further, the rotational angle (rotational angle data; [unit: °]) is expressed by a tilt with a coordinate position (surface vertex position) of the surface vertex determined by the right-hand XYZ orthogonal coordinate being the center.

Concretely, the rotational angle is expressed by a rotational angle about an axis (rotation about X, rotation about Y, rotation about Z) in the respective directions (X coordinate, Y coordinate, Z coordinate) where the surface vertex of the respective surfaces (si) is the center. Counterclockwise directions with respect to the positive (forward direction) in the X axis and Y axis are positive rotation about X and positive rotation about Y. That is to say, the rotational angle is defined to a positive direction (positive). On the other hand, a clockwise direction with respect to the positive in the Z axis is defined as rotation about Z in the positive direction.

TABLE 5

| | Coefficient of free-form surface of s2 | | | | | |
|---|---|---|---|---|---|---|
| FIRST EMBODIMENT | C4 | 1.693E−02 | C6 | 1.980E−05 | C8 | −9.848E−04 |
| | C10 | −8.585E−05 | C11 | 8.873E−05 | C13 | −6.206E−05 |
| | C15 | 1.427E−05 | | | | |
| | Coefficient of free-form surface of s3 | | | | | |
| | C4 | 9.813E−03 | C6 | 1.281E−03 | C8 | −8.489E−04 |
| | C10 | −1.513E−04 | C11 | 1.214E−04 | C13 | 1.790E−06 |
| | C15 | −1.111E−05 | | | | |
| | Coefficient of free-form surface of s4 | | | | | |
| | C4 | 1.693E−02 | C6 | 1.980E−05 | C8 | −9.848E−04 |
| | C10 | −8.585E−05 | C11 | 8.873E−05 | C13 | −6.206E−05 |
| | C15 | 1.427E−05 | | | | |
| | Coefficient of free-form surface of s5 | | | | | |
| | C3 | −1.665E−02 | C4 | −1.946E−02 | C6 | 2.919E−02 |
| | C8 | −2.382E−03 | C10 | 6.643E−03 | C11 | 5.035E−04 |
| | C13 | −1.425E−03 | C15 | 2.204E−04 | C17 | −1.859E−05 |
| | C19 | 2.593E−04 | C21 | −5.891E−04 | C22 | −5.831E−06 |
| | C24 | −1.757E−06 | C26 | −6.914E−05 | C28 | 4.130E−05 |
| | Coefficient of free-form surface of s6 | | | | | |
| | C3 | −1.140E−02 | C4 | 1.037E−01 | C6 | 1.361E−01 |
| | C8 | 2.635E−03 | C10 | 8.721E−03 | C11 | 1.897E−03 |
| | C13 | 2.004E−03 | C15 | −3.230E−04 | C17 | 7.542E−05 |
| | C19 | 1.527E−03 | C21 | 4.131E−04 | C22 | 3.407E−05 |
| | C24 | −7.964E−05 | C26 | −5.552E−04 | C28 | −1.153E−04 |
| | Coefficient of free-form surface of s7 | | | | | |
| | C4 | 1.703E−02 | C6 | −1.182E−02 | C8 | 1.871E−03 |
| | C10 | −5.428E−04 | C11 | 3.402E−05 | C13 | −2.422E−04 |
| | C15 | −6.295E−05 | | | | |
| | Coefficient of free-form surface of s8 | | | | | |
| | C4 | 1.458E−02 | C6 | −1.851E−01 | C8 | 9.380E−03 |
| | C10 | 1.027E−02 | C11 | −6.394E−04 | C13 | −9.787E−03 |
| | C15 | −1.342E−02 | | | | |
| | Coefficient of free-form surface of s9 | | | | | |
| | C4 | −4.583E−02 | C6 | 5.105E−02 | C8 | −6.378E−03 |
| | C10 | −1.124E−02 | C11 | 1.400E−03 | C13 | 4.654E−03 |
| | C15 | −1.008E−02 | | | | |
| | Coefficient of free-form surface of s10 | | | | | |
| | C4 | 1.449E−02 | C6 | 2.288E−02 | C8 | 1.365E−03 |
| | C10 | −2.302E−03 | C11 | −2.826E−04 | C13 | 3.527E−04 |
| | C15 | −1.312E−04 | | | | |
| | Coefficient of free-form surface of s11 | | | | | |
| | C4 | −8.605E−02 | C6 | 1.884E−01 | C8 | 1.083E−02 |
| | C10 | −1.662E−02 | C11 | 1.862E−03 | C13 | 4.881E−03 |
| | C15 | −3.198E−02 | | | | |

TABLE 6

| | Coefficient of free-form surface of s2 | | | | | |
|---|---|---|---|---|---|---|
| SECOND EMBODIMENT | C3 | −1.779E−02 | C4 | 1.506E−02 | C6 | 8.542E−03 |
| | C8 | −2.223E−03 | C10 | −8.926E−04 | C11 | 1.186E−04 |
| | C13 | 6.777E−05 | C15 | 2.791E−06 | C17 | −2.661E−05 |
| | C19 | −1.237E−05 | C21 | −6.103E−06 | C22 | −5.178E−06 |
| | C24 | −9.986E−07 | C26 | −4.507E−07 | C28 | 1.697E−07 |
| | Coefficient of free-form surface of s3 | | | | | |
| | C3 | 2.405E−03 | C4 | 1.678E−02 | C6 | −3.919E−03 |
| | C8 | −1.626E−03 | C10 | −1.775E−03 | C11 | −4.103E−05 |
| | C13 | 9.959E−05 | C15 | 1.466E−04 | C17 | −3.499E−05 |
| | C19 | −2.324E−05 | C21 | 2.157E−07 | C22 | −5.214E−07 |
| | C24 | 1.326E−09 | C26 | 3.494E−07 | C28 | −2.580E−07 |
| | Coefficient of free-form surface of s4 | | | | | |
| | C3 | −1.779E−02 | C4 | 1.506E−02 | C6 | 8.542E−03 |
| | C8 | −2.223E−03 | C10 | −8.926E−04 | C11 | 1.186E−04 |
| | C13 | 6.777E−05 | C15 | 2.791E−06 | C17 | −2.661E−05 |
| | C19 | −1.237E−05 | C21 | −6.103E−06 | C22 | −5.178E−06 |
| | C24 | −9.986E−07 | C26 | −4.507E−07 | C28 | 1.697E−07 |
| | Coefficient of free-form surface of s5 | | | | | |
| | C3 | 4.042E−02 | C4 | −2.378E−02 | C6 | −4.094E−02 |
| | C8 | −1.034E−02 | C10 | −7.445E−03 | C11 | 3.027E−04 |
| | C13 | 4.419E−03 | C15 | 2.822E−03 | C17 | 4.963E−04 |
| | C19 | −1.065E−04 | C21 | −3.036E−04 | C22 | −1.169E−04 |
| | C24 | −2.670E−04 | C26 | −1.554E−04 | C28 | −6.637E−05 |
| | Coefficient of free-form surface of s6 | | | | | |
| | C3 | 4.520E−02 | C4 | 9.910E−02 | C6 | −1.775E−02 |
| | C8 | −9.908E−04 | C10 | 2.121E−02 | C11 | −1.099E−03 |
| | C13 | 7.969E−03 | C15 | 7.972E−03 | C17 | 1.235E−03 |
| | C19 | 5.324E−04 | C21 | −1.747E−03 | C22 | −9.584E−04 |
| | C24 | −8.892E−04 | C26 | −5.084E−04 | C28 | −1.531E−04 |
| | Coefficient of free-form surface of s7 | | | | | |
| | C3 | −2.643E−02 | C4 | −2.598E−03 | C6 | −9.859E−03 |
| | C8 | 3.879E−04 | C10 | −3.589E−04 | C11 | −1.498E−04 |
| | C13 | −9.901E−05 | C15 | 1.639E−04 | C17 | 2.531E−04 |
| | C19 | −9.316E−05 | C21 | −4.157E−05 | C22 | −2.140E−05 |
| | C24 | 9.575E−05 | C26 | 8.039E−06 | C28 | 4.093E−06 |
| | Coefficient of free-form surface of s8 | | | | | |
| | C3 | 1.079E−01 | C4 | 2.109E−01 | C6 | −1.104E−03 |
| | C8 | 1.327E−03 | C10 | −2.233E−02 | C11 | −1.376E−03 |
| | C13 | 6.230E−03 | C15 | 4.029E−03 | C17 | 1.699E−03 |
| | C19 | −5.133E−04 | C21 | 1.337E−03 | C22 | 7.940E−04 |
| | C24 | 1.255E−03 | C26 | 3.243−04 | C28 | 3.457E−04 |
| | Coefficient of free-form surface of s9 | | | | | |
| | C3 | 1.552E−01 | C4 | 1.613E−01 | C6 | 9.568E−02 |
| | C8 | −1.531E−02 | C10 | −2.191E−02 | C11 | 3.212E−03 |
| | C13 | 6.137E−03 | C15 | 7.989E−04 | C17 | 2.908E−04 |
| | C19 | 1.536E−03 | C21 | 1.527E−03 | C22 | 1.692E−03 |
| | C24 | 2.042E−03 | C26 | 8.699E−04 | C28 | 6.363E−05 |
| | Coefficient of free-form surface of s10 | | | | | |
| | C3 | −3.366E−02 | C4 | 5.905E−03 | C6 | 2.830E−02 |
| | C8 | −2.302E−03 | C10 | −1.741E−03 | C11 | 6.503E−05 |
| | C13 | −5.767E−04 | C15 | −3.407E−04 | C17 | 6.362E−05 |
| | C19 | −2.009E−05 | C21 | 6.182E−05 | C22 | −9.303E−06 |
| | C24 | 3.215E−05 | C26 | 3.477E−06 | C28 | 3.476E−06 |
| | Coefficient of free-form surface of s11 | | | | | |
| | C3 | −5.477E−01 | C4 | −3.963E−02 | C6 | 1.220E−02 |
| | C8 | 3.715E−03 | C10 | −3.689E−02 | C11 | 1.394E−02 |
| | C13 | 1.214E−02 | C15 | 4.326E−02 | C17 | 1.566E−03 |
| | C19 | −1.698E−03 | C21 | 1.202E−02 | C22 | −1.113E−03 |
| | C24 | −1.243E−03 | C26 | −4.326E−04 | C28 | −7.302E−03 |

Tables 5 and 6 show coefficients of free-form surface on the respective surfaces. The free-form surface is concretely defined by the following definitional equation using a local orthogonal coordinate (x,y,z) whose original point is the surface vertex. The tables 5 and 6, therefore, show the coefficients of the free-form surface to be used in the following definitional equation.

The coefficients of unshown items are 0 (for all the free-form surfaces, k=0), and for all data, E−n=x 10−n.

$$z = c \cdot {h}^{2} / \{ 1 + \sqrt{1 - ( 1 + k ) {c}^{2} {h}^{2}} \} + {\sum }_{j = 2}^{66} {C}_{j} {x}^{m} {y}^{n} \qquad [ Equation 1 ]$$

In this definitional equation,
z: the amount of displacement in the z axial direction in position where the height is h (based on surface vertex)
h: the height in a direction vertical to the z axis (h2=x2+y2)
c: paraxial curvature (=1/curvature radius)
k: the coefficient of circular cone

Cj: the coefficient of free-form surface and the term of the free-form surface is expressed by the following equation:

$$\begin{matrix}{\sum }_{j = 2}^{66} {C}_{j} {x}^{m} {y}^{n} = {C}_{2} \cdot x + {C}_{3} \cdot y + \\ {C}_{4} \cdot {x}^{2} + {C}_{5} \cdot x \cdot y + {C}_{6} \cdot {y}^{2} + \\ {C}_{7} \cdot {x}^{3} + {C}_{8} \cdot {x}^{2} \cdot y + {C}_{9} \cdot x \cdot {y}^{2} + {C}_{10} \cdot {y}^{3} + \\ {C}_{11} \cdot {x}^{4} + {C}_{12} \cdot {x}^{3} \cdot y + {C}_{13} \cdot {x}^{2} \cdot {y}^{2} + \\ {C}_{14} \cdot x \cdot {y}^{3} + {C}_{15} \cdot {y}^{4} + {C}_{16} \cdot {x}^{5} + \\ {C}_{17} \cdot {x}^{4} \cdot y + {C}_{18} \cdot {x}^{3} \cdot {y}^{2} + {C}_{19} \cdot {x}^{2} \cdot \\ {y}^{3} + {C}_{20} \cdot x \cdot {y}^{4} + {C}_{21} \cdot {y}^{5} + \\ {C}_{22} \cdot {x}^{6} + {C}_{23} \cdot {x}^{5} \cdot y + {C}_{24} \cdot {x}^{4} \cdot {y}^{2} + \\ {C}_{25} \cdot {x}^{3} \cdot {y}^{3} + {C}_{26} \cdot {x}^{2} \cdot {y}^{4} + {C}_{27} \cdot x \cdot {y}^{5} + \\ {C}_{28} \cdot {y}^{6} + …\end{matrix} \qquad [ Equation 2 ]$$

TABLE 7
FIRST EMBODIMENT

| Focal Length [mm] | | 6.0 |
|---|---|---|
| F number [Fno] | | 2.8 |
| Radius of optical diaphragm [mm] | | 1.15 |
| (in the case of circular shape) | | |
| Half field angle [°] | Horizontal direction (X direction) | 26.3 |
| | Vertical direction (Y direction) | 19.7 |
| Size of image | Horizontal direction (X direction) | 5.74 |
| surface | Vertical direction (Y direction) | 4.30 |

TABLE 8
SECOND EMBODIMENT

| Focal Length [mm] | | 6.0 |
|---|---|---|
| F number [Fno] | | 2.8 |
| Radius of optical diaphragm [mm] | | 1.05 |
| (in the case of circular shape) | | |
| Half field angle [°] | Horizontal direction (X direction) | 26.3 |
| | Vertical direction (Y direction) | 19.7 |
| Size of image | Horizontal direction (X direction) | 5.74 |
| surface | Vertical direction (Y direction) | 4.30 |

The tables 7 and 8 show the focal distance [unit; mm], f number [F no] and a radius [unit: mm] of the optical diaphragm ST (in the case of circular one) in the entire imaging optical system OS. Tables 7 and 8 also show a half field angle [unit: °] in the horizontal direction (direction X) and the vertical direction (direction Y), and a length [unit; mm] of an image surface size in the horizontal direction (longitudinal side; long side) and a vertical direction (widthwise side; short side).

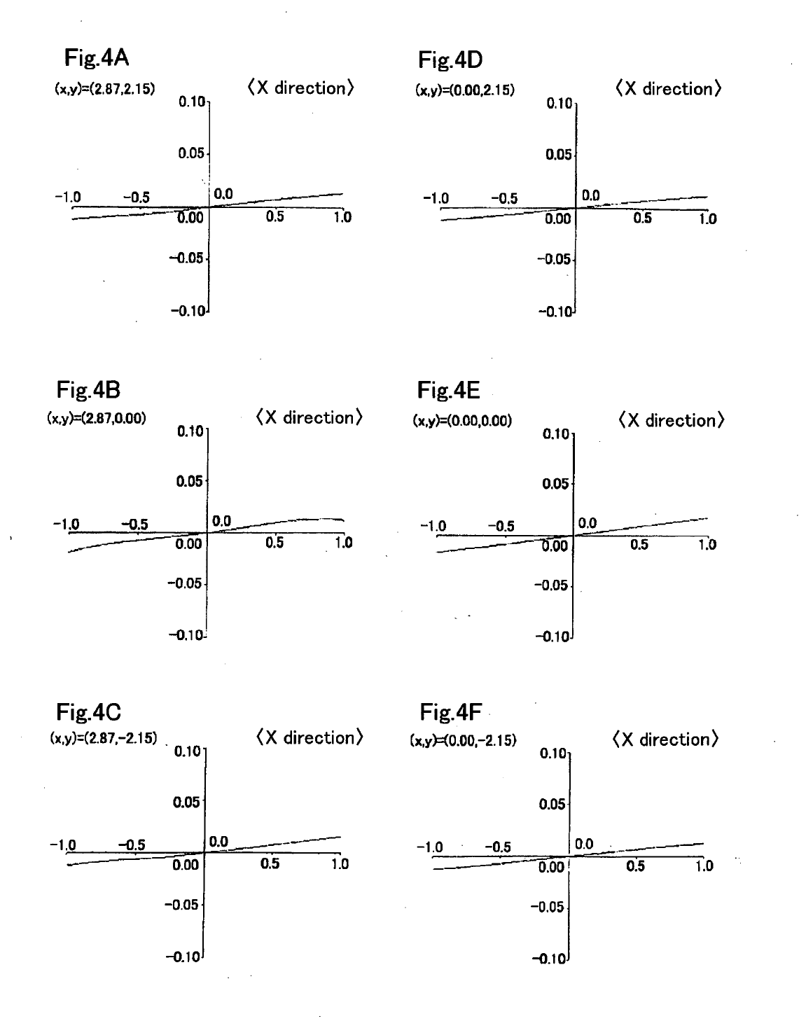

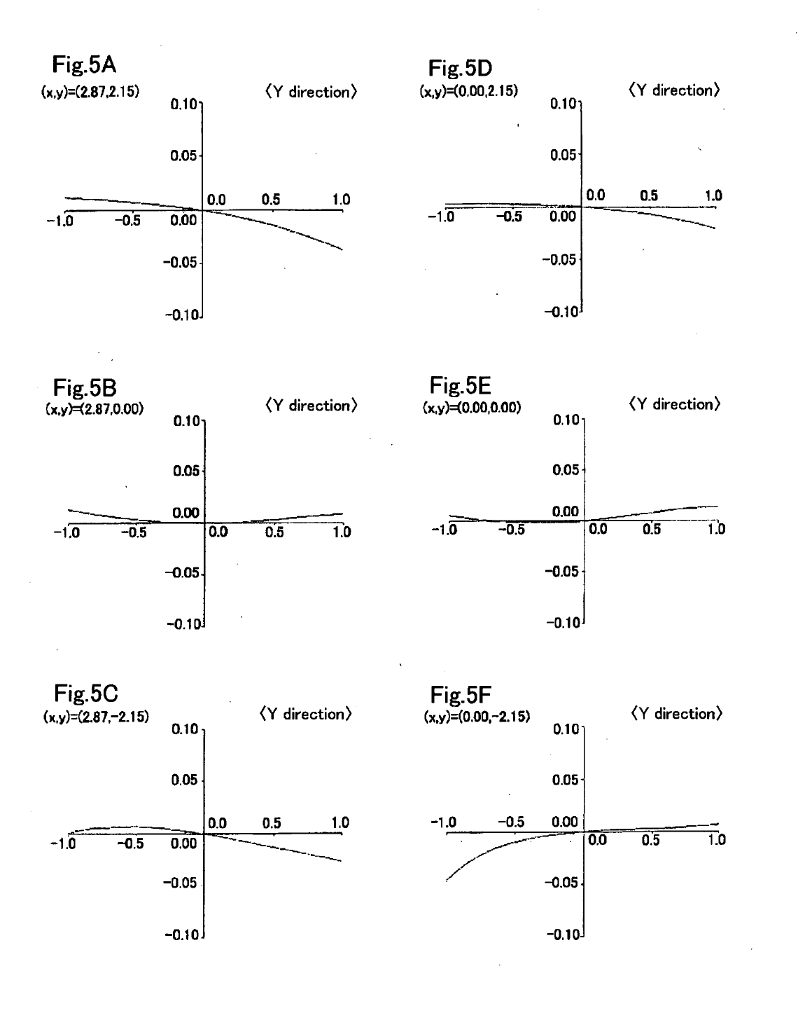

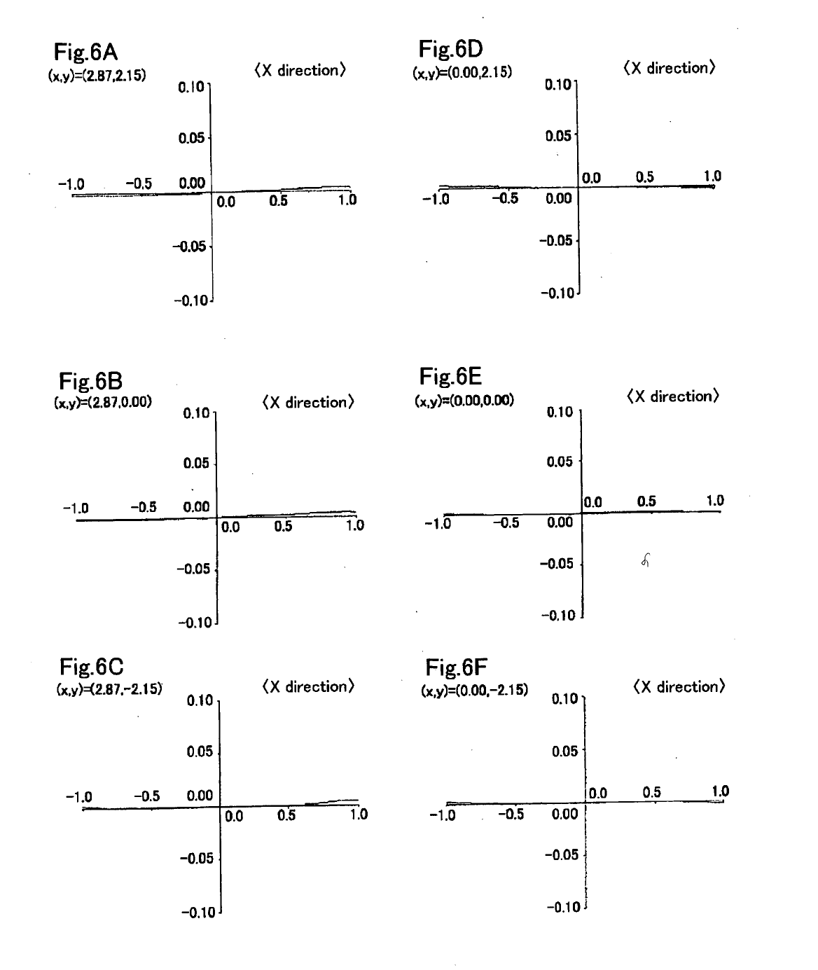

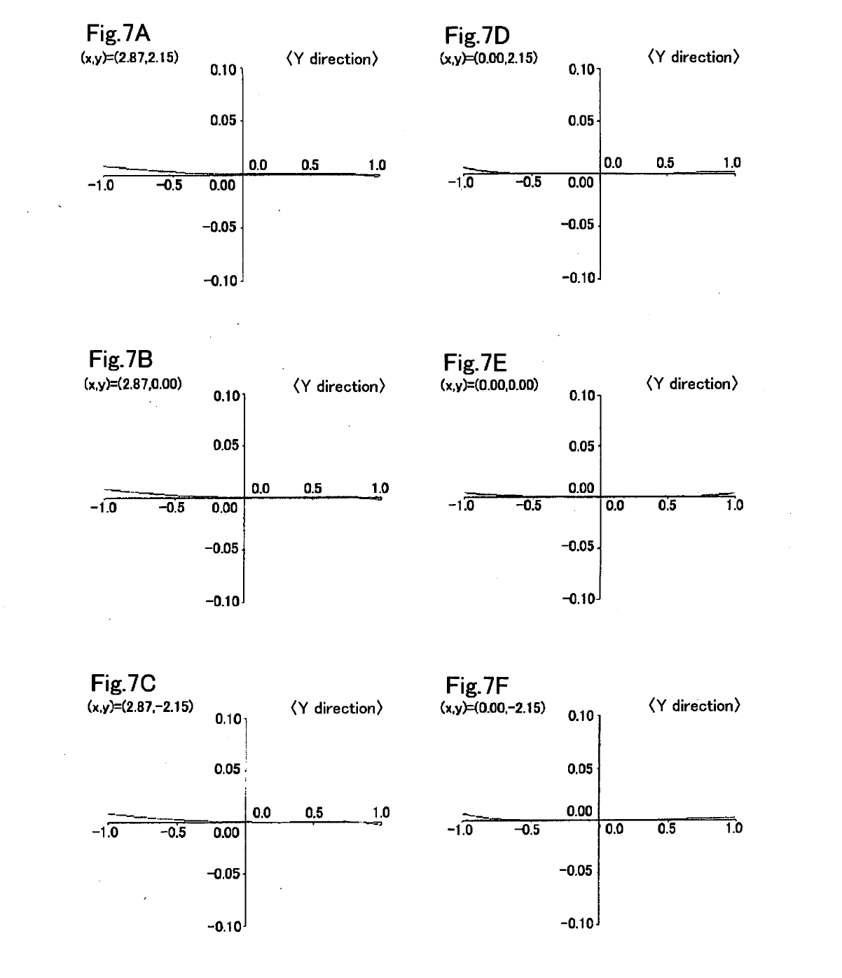

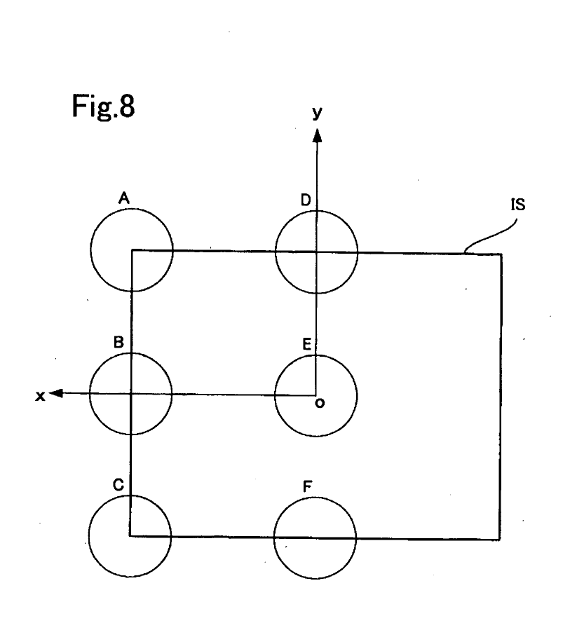

FIGS. 4A to 4F and FIGS. 5A to 5F are lateral aberration charts of the image taking apparatus ITA in the first embodiment (in a second embodiment, the lateral aberration corresponding to FIGS. 4A to 4F is the lateral aberration in FIGS. 6A to 6F, and the lateral aberration corresponding to FIGS. 5A to 5F is the lateral aberration in FIGS. 7A to 7F). Concretely, FIGS. 4A to 4F show the lateral aberration in the direction X (horizontal direction), and FIGS. 5A to 5F show the lateral aberration in the direction Y (vertical direction). These lateral aberration charts show the lateral aberration [unit; mm] at the image height [unit: mm] expressed by the local orthogonal coordinate (x,y) on the image surface IS (see FIG. 8) with respect to the line d.

That is to say, FIGS. 4A to 4C and FIGS. 5A to 5C correspond to three places on the positive side of the direction x in the local orthogonal coordinate system (x,y) where the center of the image surface IS is the original point o {three places (positions of circles A to C) on one short side on the image surface IS}. Further, FIGS. 4D to 4F and FIGS. 5D to 5F correspond to three places on both the positive and negative sides in the direction y including the original point o {three places (positions of circles D to F) along the direction y including the center of the image surface IS}). The scale of the lateral aberration diagram in FIGS. 4 to 7 is the axis of ordinate [−0.10 to 0.10] and the axis of abscissa [−1.0 to 0.1].

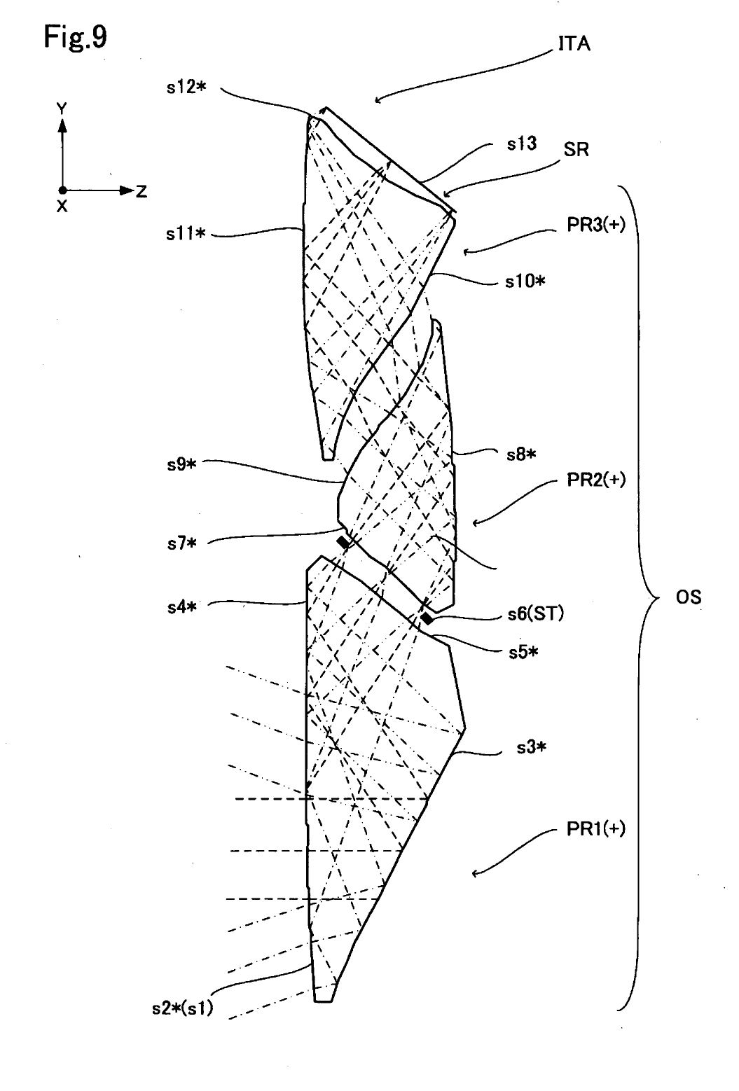

FIG. 9 is an optical sectional view illustrating the image taking apparatus ITA in a third embodiment. Like members having the similar functions to those of the members in the first and second embodiments are designated by like numerals, and the explanation thereof is not repeated.

The image taking apparatus ITA of the third embodiment has the prisms PR1 to PR3 similarly to the image taking apparatus ITA of the first and second embodiments. The imaging optical system OS in the image taking apparatus ITA of the third embodiment includes the prisms PR1 to PR3 which provide positive power (+) differently from the imaging optical system OS in the first and second embodiments. That is to say, all the prisms PR1 to PR3 of the imaging optical system OS provide the positive power (+). The present invention is not limited to the imaging optical system where all the prism elements have the positive power.

In the imaging optical system OS in the third embodiment, the optical diaphragm ST is not provided on the optical working surfaces, and the independent optical diaphragm ST is provided between the prism PR1 and the prism PR2. The image taking apparatus ITA in the third embodiment includes the first prism PR1, the optical diaphragm ST, the second prism PR2, the third prism PR3 and the imaging device SR. The optical diaphragm ST can be arranged on the working surfaces of the prism elements or between the prism elements. That is to say, even when the optical diaphragm is provided in any places, this does not limit the present invention.

The first prism PR1 has four optical working surfaces (s2 to s5). The first surface s1 is a dummy surface (reference surface) similarly to the first and second embodiments. The surface (incident surface) which firstly receives the light ray from the object and allows it to transmit through is, therefore, described as the second surface s2 in FIG. 9. The third surface s3 is a reflection surface which reflects the light ray transmitting (passing) through the second surface s2 towards the fourth surface s4.

The fourth surface s4 is a reflection surface which reflects the light ray (reflected light ray) reflected by the third surface s3 toward the fifth surface s5. As shown in FIG. 9, the second surface s2 and the fourth surface s4 are TIR surfaces having both the transmitting and reflecting functions.

The fifth surface s5 is an emission surface (transmission surface) which allows the reflected light ray from the fourth surface s4 to emit (transmit) toward the second prism PR2. The fifth surface s5 and the sixth surface s6, mentioned later, are arranged so as to be opposed to each other.

The optical diaphragm ST has a circular diaphragm shape, and is provided between the fifth surface s5 of the first prism PR1 and a seventh surface s7 of the second prism PR2. The optical diaphragm ST is called also as the sixth surface s6 for transmitting the light ray.

The second prism PR2 is a prism element which leads the light ray passing through the first prism PR1 and partially shielded by the optical diaphragm ST to the third prism PR3. The second prism element PR2 has three optical working surfaces (s7 to s9).

The seventh surface s7 is an incident surface (transmission surface) which first receives the light ray from the first prism PR1 and allows it to transmit through. An eighth surface s8 is a reflection surface which reflects the light ray (transmitted light ray) passing through the seventh surface s7 towards a ninth surface s9. Further, the ninth surface s9 is an emission surface (transmission surface) which allows the light ray (reflected light ray) from the eighth surface s8 to emit (transmit) towards the third prism PR3. The ninth surface s9 and a tenth surface s10, mentioned later, are opposed to each other.

The third prism PR3 is a prism which leads the light ray passing through the second prism PR2 to the imaging device SR (image surface s13). The third prism PR3 has three optical working surfaces (s10 to s12).

The tenth surface s10 is an incident surface (transmission surface) which firstly receives the light ray from the second prism PR2 and allows it to transmit through. An eleventh surface s11 is a reflection surface which reflects the light ray (transmitted light ray) passing through the tenth surface s10 towards the twelfth surface s12. Further, a twelfth surface s12 is an emission surface (transmission surface) which allows the light ray (reflected light ray) from the eleventh surface s11 to emit (transmit) towards the imaging device SR (image surface s13).

Construction data in the image taking apparatus ITA of the third embodiment are explained with reference to Tables 9 to 12. Table 9 has the similar expression to the Table 1, Table 10 has the similar expression to Table 3, Table 11 has the similar expression to Table 5, and Table 12 has the similar expression to Table 7.

TABLE 9
THIRD EMBODIMENT

| si | i | ri[mm] | | i | Ni | νi | Optical Element |
|---|---|---|---|---|---|---|---|
| s1 | 1 | ∞ | Reference | | Air | Air | PR1(+) |
| | | | surface | | | | |
| s2* | 2 | ∞ | Incident | 1 | 1.49 | 70.4 | |
| | | | surface | | | | |
| s3* | 3 | ∞ | Reflection | 2 | 1.49 | 70.4 | |
| | | | surface | | | | |
| s4* | 4 | ∞ | Reflection | 3 | 1.49 | 70.4 | |
| | | | surface | | | | |
| s5* | 5 | ∞ | Emission | | Air | Air | ST |
| | | | surface | | | | |
| s6 | 6 | ∞ | Optical | | | | PR2(+) |
| | | | diaphragm | | | | |
| s7* | 7 | ∞ | Incident | 4 | 1.53 | 55.7 | |
| | | | surface | | | | |
| s8* | 8 | ∞ | Reflection | 5 | 1.53 | 55.7 | |
| | | | surface | | | | |
| s9* | 9 | ∞ | Emission | | Air | Air | PR3(+) |
| | | | surface | | | | |
| s10* | 10 | ∞ | Incident | 6 | 1.53 | 55.7 | |
| | | | surface | | | | |
| s11* | 11 | ∞ | Reflection | 7 | 1.53 | 55.7 | |
| | | | surface | | | | |
| s12 | 12 | ∞ | Emission | | Air | Air | SR |
| | | | surface | | | | |
| s13 | 13 | ∞ | Image | | | | |
| | | | surface | | | | |

TABLE 10
THIRD EMBODIMENT

| | Surface Vertex Coordinate [mm] | | | Rotational Angle [°] | | |
|---|---|---|---|---|---|---|
| si | X Coordinate | Y Coordinate | Z Coordinate | Rotation about X | Rotation about Y | Rotation about Z |
| s1 | 0.000 | 0.000 | 0.000 | 0.00 | 0.00 | 0.00 |
| s2* | 0.000 | 0.000 | 0.000 | 0.00 | 0.00 | 0.00 |
| s3* | 0.000 | 0.000 | 2.500 | −28.00 | 0.00 | 0.00 |
| s4* | 0.000 | 0.000 | 0.000 | 0.00 | 0.00 | 0.00 |
| s5* | 0.000 | 6.535 | 1.771 | 54.86 | 0.00 | 0.00 |
| s6 | 0.000 | 6.891 | 2.007 | 54.86 | 0.00 | 0.00 |
| s7* | 0.000 | 7.100 | 2.138 | 55.18 | 0.00 | 0.00 |
| s8* | 0.000 | 9.644 | 3.818 | 2.19 | 0.00 | 0.00 |
| s9* | 0.000 | 11.200 | 2.200 | −39.55 | 0.00 | 0.00 |
| s10* | 0.000 | 12.100 | 1.500 | −40.00 | 0.00 | 0.00 |
| s11* | 0.000 | 13.324 | −0.097 | 3.58 | 0.00 | 0.00 |
| s12* | 0.000 | 17.273 | 1.851 | 40.71 | 0.00 | 0.00 |
| s13 | 0.000 | 17.600 | 2.143 | 52.49 | 0.00 | 0.00 |

TABLE 11

| | Coefficient of free-form surface of s2 | | | | | |
|---|---|---|---|---|---|---|
| THIRD EMBODIMENT | C3 | −2.483E−02 | C4 | 2.118E−02 | C6 | 8.235E−03 |
| | C8 | −3.092E−03 | C10 | −8.775E−04 | C11 | −1.003E−04 |
| | C13 | 8.701E−05 | C15 | 2.496E−05 | C17 | 4.768E−05 |
| | C19 | −4.093E−05 | C21 | −3.410E−06 | C22 | −6.031E−06 |
| | C24 | −6.312E−06 | C26 | 3.872E−06 | C28 | 1.867E−07 |
| | Coefficient of free-form surface of s3 | | | | | |
| | C4 | 2.854E−02 | C6 | 1.862E−04 | C8 | −3.224E−03 |
| | C10 | −9.992E−04 | C11 | 2.713E−04 | C13 | 3.085E−04 |
| | C15 | 1.938E−04 | | | | |
| | Coefficient of free-form surface of s4 | | | | | |
| | C3 | −2.483E−02 | C4 | 2.118E−02 | C6 | 8.235E−03 |
| | C8 | −3.092E−03 | C10 | −8.775E−04 | C11 | −1.003E−04 |
| | C13 | 8.701E−05 | C15 | 2.496E−05 | C17 | 4.768E−05 |
| | C19 | −4.093E−05 | C21 | −3.410E−06 | C22 | −6.031E−06 |
| | C24 | −6.312E−06 | C26 | 3.872E−06 | C28 | 1.867E−07 |
| | Coefficient of free-form surface of s5 | | | | | |
| | C3 | 3.995E−02 | C4 | −1.092E−01 | C6 | −3.643E−02 |
| | C8 | −5.429E−03 | C10 | −9.567E−03 | C11 | 4.581E−03 |
| | C13 | 3.857E−03 | C15 | 2.270E−03 | C17 | −1.040E−04 |
| | C19 | 9.354E−4 | C21 | −1.066E−03 | C22 | −5.117E−04 |
| | C24 | −9.425E−04 | C26 | −3.594E−04 | C28 | 9.809E−05 |
| | Coefficient of free-form surface of s7 | | | | | |
| | C3 | 9.264E−02 | C4 | 5.188E−02 | C6 | −1.953E−02 |
| | C8 | 1.980E−03 | C10 | 1.626E−02 | C11 | 5.410E−03 |
| | C13 | 6.450E−03 | C15 | 1.087E−03 | C17 | −1.128E−05 |
| | C19 | 3.171E−04 | C21 | −1.063E−03 | C22 | −5.991E−04 |
| | C24 | −1.235E−03 | C26 | −3.950E−04 | C28 | −2.840E−06 |
| | Coefficient of free-form surface of s8 | | | | | |
| | C3 | −7.263E−03 | C4 | −9.069E−03 | C6 | −1.460E−02 |
| | C8 | −1.894E−03 | C10 | −3.893E−05 | C11 | 1.787E−04 |
| | C13 | −3.338E−04 | C15 | −2.421E−05 | C17 | 1.533E−05 |
| | C19 | −8.605E−05 | C21 | −6.836E−06 | C22 | −6.122E−05 |
| | C24 | −5.298E−05 | C26 | −5.851E−08 | C28 | −1.398E−06 |
| | Coefficient of free-form surface of s9 | | | | | |
| | C3 | −1.915E−02 | C4 | −8.429E−02 | C6 | −4.602E−02 |
| | C8 | −7.142E−03 | C10 | −2.659E−02 | C11 | 4.532E−03 |
| | C13 | −3.748E−03 | C15 | 3.259E−03 | C17 | −6.336E−04 |
| | C19 | −1.623E−03 | C21 | 1.171E−05 | C22 | −4.401E−04 |
| | C24 | −6.888E−04 | C26 | 1.102E−04 | C28 | −6.068E−05 |
| | Coefficient of free-form surface of s10 | | | | | |
| | C3 | −1.007E−01 | C4 | −4.922E−02 | C6 | 6.233E−02 |
| | C8 | −3.924E−03 | C10 | −1.954E−02 | C11 | 5.616E−03 |
| | C13 | 1.610E−03 | C15 | −3.747E−03 | C17 | −2.473E−03 |
| | C19 | −8.748E−04 | C21 | −2.812E−04 | C22 | 2.753E−04 |
| | C24 | 6.332E−04 | C26 | 2.563E−04 | C28 | 3.544E−04 |
| | Coefficient of free-form surface of s11 | | | | | |
| | C3 | −2.252E−02 | C4 | −2.368E−03 | C6 | 2.383E−02 |
| | C8 | −9.354E−04 | C10 | 5.590E−04 | C11 | 4.629E−04 |
| | C13 | −4.293E−04 | C15 | −4.350E−04 | C17 | −2.311E−04 |
| | C19 | −1.535E−04 | C21 | −3.368E−05 | C22 | −4.935E−05 |
| | C24 | 1.138E−04 | C26 | 2.526E−05 | C28 | 1.202E−05 |
| | Coefficient of free-form surface of s12 | | | | | |
| | C3 | −2.402E−01 | C4 | −1.850E−01 | C6 | −5.770E−03 |
| | C8 | −5.315E−03 | C10 | −3.485E−02 | C11 | 3.768E−02 |
| | C13 | 3.376E−02 | C15 | 5.224E−02 | C17 | 1.595E−03 |
| | C19 | −7.314E−03 | C21 | 7.509E−03 | C22 | −2.263E−03 |
| | C24 | −3.989E−03 | C26 | 1.326E−03 | C28 | −8.939E−03 |

TABLE 12
THIRD EMBODIMENT

| Focal Length [mm] | | 6.0 |
|---|---|---|
| F number [Fno] | | 2.8 |
| Radius of optical diaphragm [mm] | | 1.24 |
| (in the case of circular shape) | | |
| Half field angle [°] | Horizontal direction (X direction) | 26.3 |
| | Vertical direction (Y direction) | 19.7 |
| Size of image | Horizontal direction (X direction) | 5.74 |
| surface | Vertical direction (Y direction) | 4.30 |

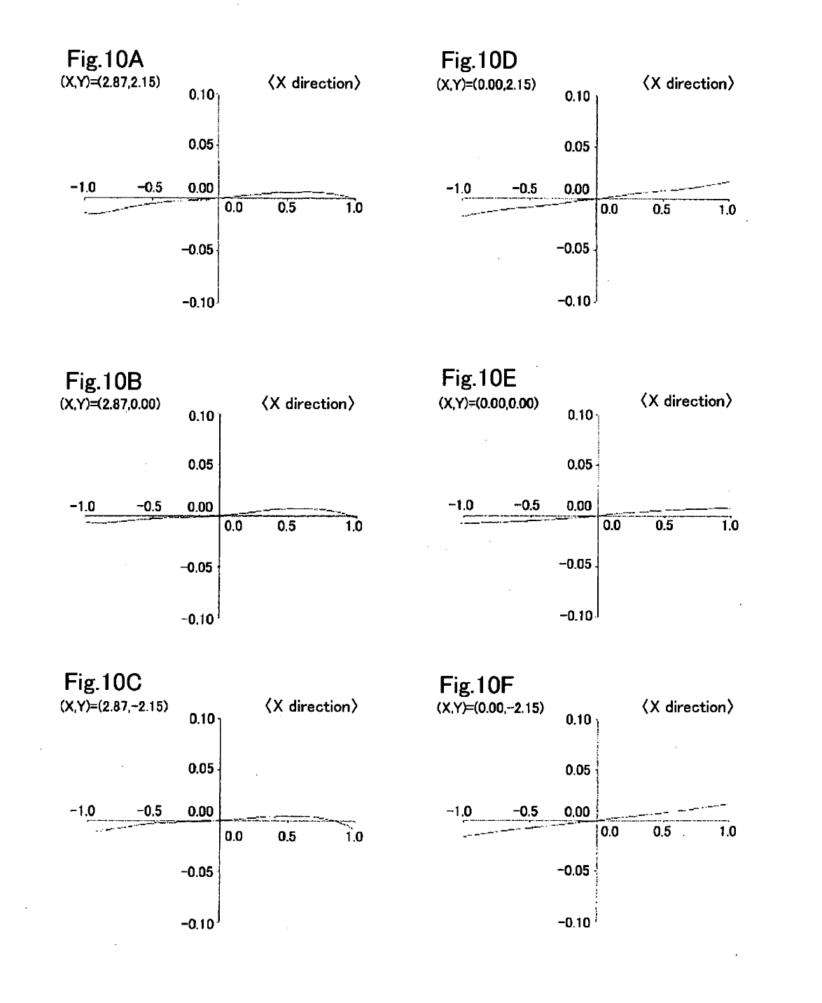

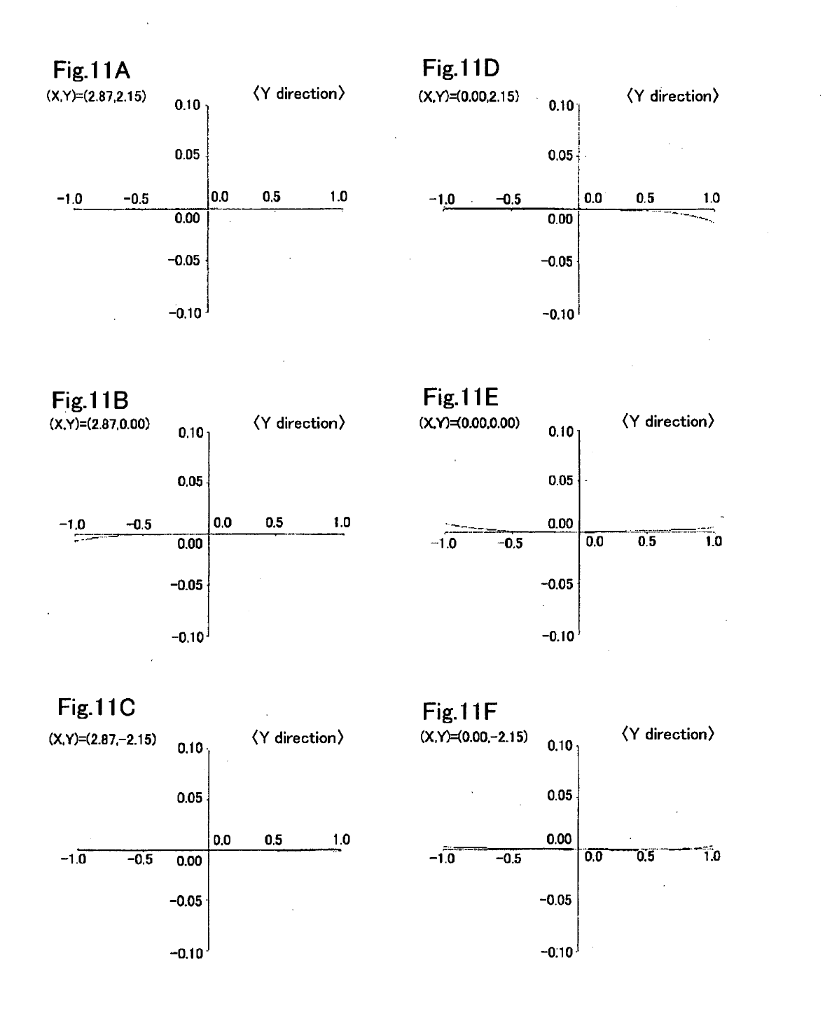

FIGS. 10A to 10F and FIGS. 11A to 11F are lateral aberration charts of the image taking apparatus ITA in the third embodiment. FIGS. 10A to 10F and FIGS. 11A to 11F have the similar expressions to those of FIGS. 4A to 4F and FIGS. 5A to 5F.

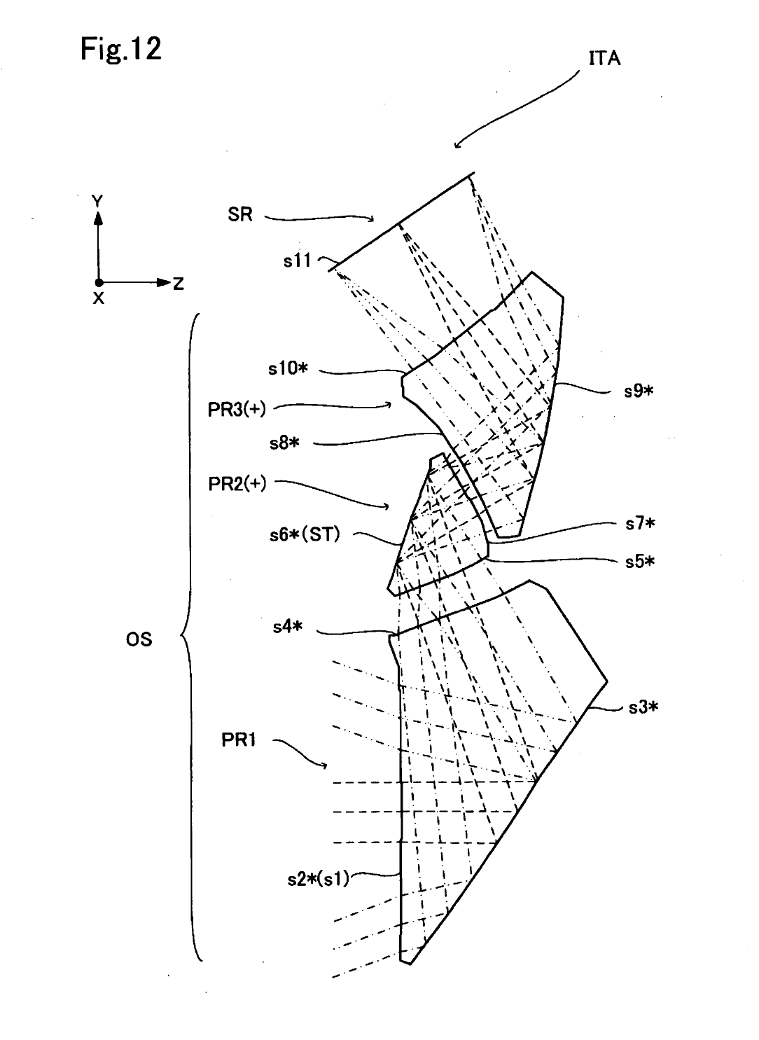

FIG. 12 is an optical sectional view illustrating the image taking apparatus ITA in a fourth embodiment. Like members having the similar functions as those of the members in the first and second embodiments are designated by like numerals, and the explanation thereof is not repeated.

The image taking apparatus ITA in the fourth embodiment has the prisms PR1 to PR3 similarly to the image taking apparatus ITA in the first to third embodiments. The imaging optical system OS of the image taking apparatus ITA in the fourth embodiment includes the second prism PR2 and the third prism PR3 which provide the positive power (+) similarly to the imaging optical system OS in the first embodiment.

The first prism PR1 in the fourth embodiment has only three surfaces composed of the incident surface, the reflection surface and the emission surface differently from the first prism PR1 in the first to third embodiments. The optical diaphragm ST in the fourth embodiment is provided on the optical working surfaces similarly to the first and second embodiments. The image taking apparatus ITA in the fourth embodiment includes the first prism PR1, the second prism PR2, the third prism PR3 and the imaging device SR.

The first prism PR1 has three optical working surfaces (s2 to s4). The first surface s1 is the dummy surface (reference surface) similarly to the first to third embodiments. The surface which firstly receives the light ray from the object and allows it to transmit through, namely, the incident surface is described as the second surface s2 in FIG. 12. The third surface s3 is the reflection surface which reflects the light ray transmitting (passing) through the second surface s2 towards the fourth surface s4.

The fourth surface s4 is the emission surface (transmission surface) which allows the light ray (reflected light ray) reflected by the third surface s3 to emit (transmit) towards the second prism PR2. The fourth surface s4 and the fifth surface s5, mentioned later, are opposed to each other.

The second prism PR2 is the prism which leads the light ray passing through the first prism PR1 to the third prism PR3. The second prism PR2 has three optical working surfaces (s5 to s7).

The fifth surface s5 is the incident surface (transmission surface) which firstly receives the light ray from the first prism PR1 and allows it to transmit through. The sixth surface s6 is the reflection surface which reflects the light ray (transmitted light ray) passing through the fifth surface s5 towards the seventh surface s7. The seventh surface s7 is an emission surface (transmission surface) which allows the light ray (reflected light ray) from the sixth surface s6 to emit (transmit) towards the third prism PR3.

The sixth surface s6 is provided with the optical diaphragm ST. The seventh surface s7 and the eighth surface s8, mentioned later, are opposed to each other.

The third prism PR3 is the prism which leads the light ray passing through the second prism PR2 to the imaging device SR (image surface s11). The third prism PR3 has three optical working surfaces (s8 to s10).

The eight surface s8 is the incident surface (transmission surface) which firstly receives the light ray from the second prism PR2 and allows it to transmit through. The ninth surface s9 is the reflection surface which reflects the light ray (transmitted light ray) passing through the eighth surface s8 towards the tenth surface s10. The tenth surface s10 is the emission surface (transmission surface) which allows the light ray (reflected light ray) from the ninth surface s9 toward the imaging device SR (image surface s11).

The construction data in the image taking apparatus ITA of the fourth embodiment are explained with reference to Tables 13 to 16. Tables 13 has the similar expression to Table 1, Table 14 has the similar expression to Table 3, Table 15 has the similar expression to Table 5, and Table 16 has the similar expression to Table 7.

TABLE 13
FOURTH EMBODIMENT

| si | i | ri[mm] | | i | Ni | νi | Optical Element |
|---|---|---|---|---|---|---|---|
| s1 | 1 | ∞ | Reference | | Air | Air | PR1 |
| | | | surface | | | | |
| s2 | 2 | ∞ | Incident | 1 | 1.53 | 55.7 | |
| | | | surface | | | | |
| s3* | 3 | ∞ | Reflection | 2 | 1.53 | 55.7 | |
| | | | surface | | | | |
| s4* | 4 | ∞ | Emission | | Air | Air | PR2(+) |
| | | | surface | | | | |
| s5* | 5 | ∞ | Incident | 3 | 1.53 | 55.7 | ST |
| | | | surface | | | | |
| s6* | 6 | ∞ | Reflection | 4 | 1.53 | 55.7 | |
| | | | surface | | | | |
| s7* | 7 | ∞ | Emission | | Air | Air | PR3(+) |
| | | | surface | | | | |
| s8* | 8 | ∞ | Incident | 5 | 1.53 | 55.7 | |
| | | | surface | | | | |
| s9* | 9 | ∞ | Reflection | 6 | 1.53 | 55.7 | |
| | | | surface | | | | |
| s10* | 10 | ∞ | Emission | | Air | Air | SR |
| | | | surface | | | | |
| s11 | 11 | ∞ | Image | | | | |
| | | | surface | | | | |

TABLE 14
FOURTH EMBODIMENT

| | Surface Vertex Coordinate [mm] | | | Rotational Angle [°] | | |
|---|---|---|---|---|---|---|
| si | X Coordinate | Y Coordinate | Z Coordinate | Rotation about X | Rotation about Y | Rotation about Z |
| s1 | 0.000 | 0.000 | 0.000 | 0.00 | 0.00 | 0.00 |
| s2* | 0.000 | 0.000 | 0.000 | 0.00 | 0.00 | 0.00 |
| s3* | 0.000 | 0.000 | 3.027 | −35.00 | 0.00 | 0.00 |
| s4* | 0.000 | 5.000 | 1.193 | −70.00 | 0.00 | 0.00 |
| s5* | 0.000 | 5.890 | 0.902 | −70.00 | 0.00 | 0.00 |
| s6* | 0.000 | 7.481 | 0.304 | −20.00 | 0.00 | 0.00 |
| s7* | 0.000 | 8.520 | 1.482 | 30.07 | 0.00 | 0.00 |
| s8* | 0.000 | 8.730 | 1.731 | 30.02 | 0.00 | 0.00 |
| s9* | 0.000 | 10.630 | 3.998 | −10.00 | 0.00 | 0.00 |
| s10* | 0.000 | 12.379 | 1.915 | −52.53 | 0.00 | 0.00 |
| s11 | 0.000 | 15.013 | −0.021 | −56.45 | 0.00 | 0.00 |

TABLE 15

| | Coefficient of free-form surface of s2 | | | | | |
|---|---|---|---|---|---|---|
| FOURTH EMBODIMENT | C4 | 4.162E−03 | C6 | −3.922E−03 | C8 | −1.386E−03 |
| | C10 | −1.211E−04 | C11 | −2.048E−05 | C13 | −1.911E−05 |
| | C15 | −3.007E−05 | | | | |
| | Coefficient of free-form surface of s3 | | | | | |
| | C4 | 6.387E−03 | C6 | 5.447E−05 | C8 | 5.172E−04 |
| | C10 | 7.039E−04 | C11 | −4.483E−06 | C13 | 5.708E−05 |
| | C15 | 3.348E−05 | | | | |
| | Coefficient of free-form surface of s4 | | | | | |
| | C4 | 3.314E−02 | C6 | −6.990E−04 | C8 | 5.646E−03 |
| | C10 | −2.336E−03 | C11 | −1.831E−03 | C13 | 6.732E−05 |
| | C15 | −5.254E−04 | | | | |
| | Coefficient of free-form surface of s5 | | | | | |
| | C4 | −2.331E−02 | C6 | −3.084E−03 | C8 | −1.530E−02 |
| | C10 | −2.196E−02 | C11 | −2.002E−03 | C13 | 3.619E−03 |
| | C15 | 4.961E−04 | | | | |
| | Coefficient of free-form surface of s6 | | | | | |
| | C4 | 9.556E−04 | C6 | 5.113E−03 | C8 | −2.822E−03 |
| | C10 | 6.408E−04 | C11 | −1.905E−04 | C13 | −4.367E−04 |
| | C15 | −4.263E−05 | | | | |
| | Coefficient of free-form surface of s7 | | | | | |
| | C4 | −4.026E−02 | C6 | 1.772E−02 | C8 | −5.048E−03 |
| | C10 | 2.196E−02 | C11 | 5.774E−04 | C13 | −1.411E−02 |
| | C15 | −7.559E−03 | | | | |
| | Coefficient of free-form surface of s8 | | | | | |
| | C4 | 1.751E−02 | C6 | −3.572E−02 | C8 | −1.429E−02 |
| | C10 | −4.862E−03 | C11 | 6.221E−04 | C13 | −6.869E−03 |
| | C15 | −4.407E−03 | | | | |
| | Coefficient of free-form surface of s9 | | | | | |
| | C4 | −7.856E−03 | C6 | −2.155E−02 | C8 | −3.994E−03 |
| | C10 | −6.716E−05 | C11 | −6.759E−05 | C13 | −3.403E−04 |
| | C15 | 1.333E−04 | | | | |
| | Coefficient of free-form surface of s10 | | | | | |
| | C4 | 7.724E−02 | C6 | −2.081E−02 | C8 | −8.735E−03 |
| | C10 | −5.429E−03 | C11 | −2.349E−03 | C13 | −8.792E−03 |
| | C15 | −2.171E−03 | | | | |

TABLE 16
FOURTH EMBODIMENT

| Focal Length [mm] | | 6.0 |
|---|---|---|
| F number [Fno] | | 3.2 |
| Radius of optical diaphragm [mm] | | 1.20 |
| (in the case of circular shape) | | |
| Half field angle [°] | Horizontal direction (X direction) | 26.3 |
| | Vertical direction (Y direction) | 19.7 |
| Size of image | Horizontal direction (X direction) | 3.90 |
| surface | Vertical direction (Y direction) | 2.88 |

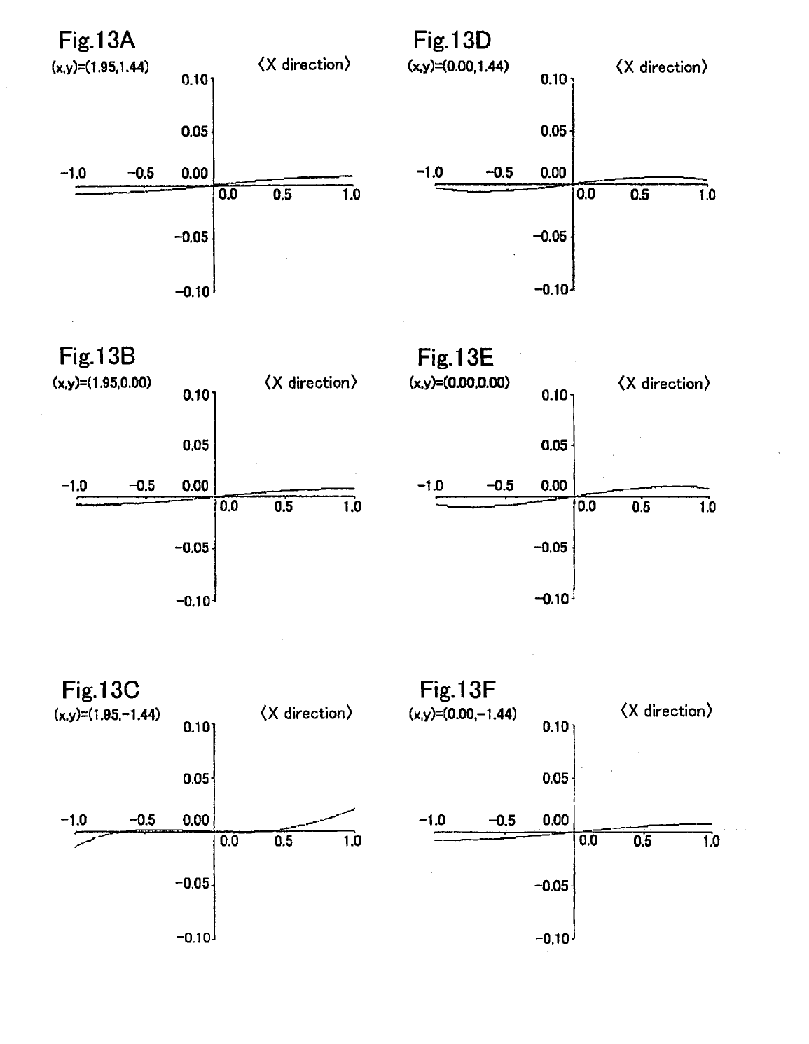

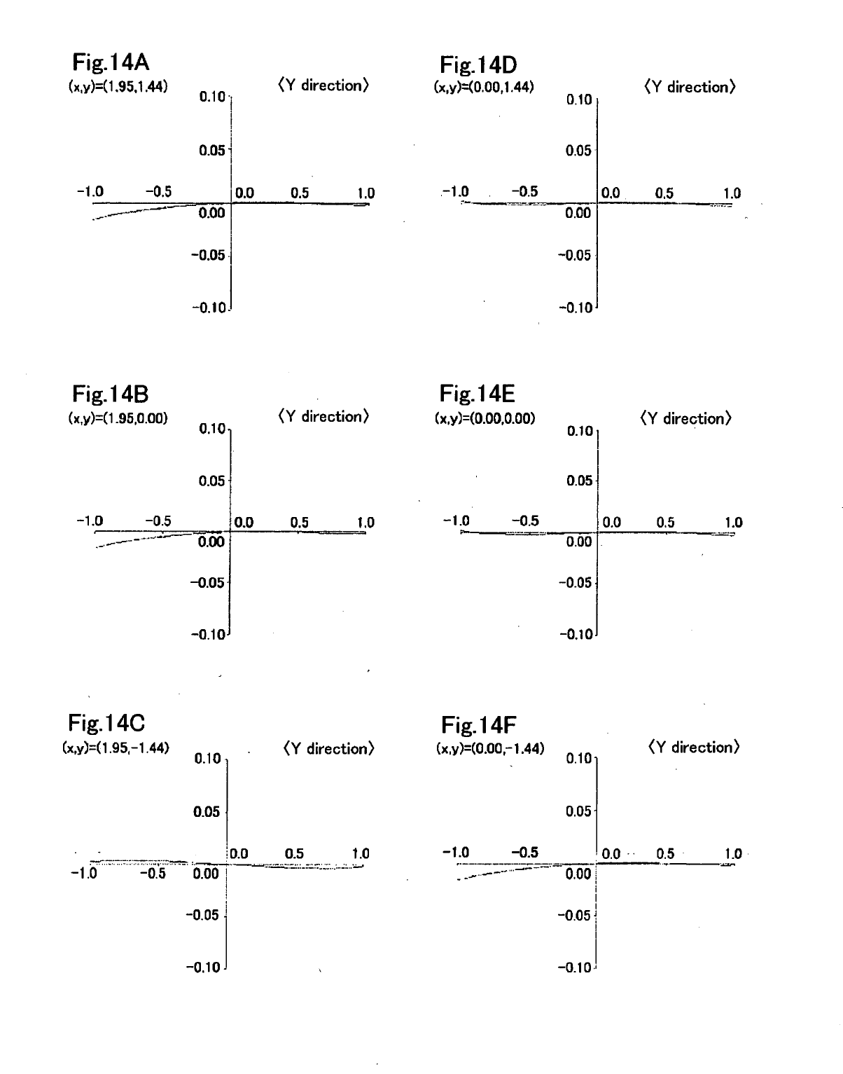

FIGS. 13A to 13F and FIGS. 14A to 14F are lateral aberration charts of the image taking apparatus ITA in the fourth embodiment. FIGS. 13A to 13F and FIGS. 14A to 14F have the similar expression to the FIGS. 4A to 4F and FIGS. 5A to 5F.

The imaging optical system OS of the present invention has the prisms PR1 to PR3 which allow the light ray from the object to pass (namely, the total number of the prism elements is at least three or more). In such a constitution, since at least about three prism elements are suitably provided, the size of the imaging optical system OS is restricted. Since at least the suitable number of the optical working surfaces (optical surfaces) are formed on the three prism elements, the imaging optical system OS which can provide high performance (high aberration correcting ability, high resolution and the like) can be realized.

In the imaging optical system OS of the present invention, at least one of the prisms PR1 to PR3 has an asymmetrical optical working surface (the prism element may have at least one asymmetrical optical surface). The asymmetrical optical surface is not a reflection surface (optical working surface) of 45° like a rectangular prism, but is a transmission surface/reflection surface having various angles with respect to advancing light ray and an asymmetrical optical working surface.

In the case of such an imaging optical system (asymmetrical optical system) OS, the light ray from the object reaches the imaging device(image surface) while the light ray is being refracted and reflected. For this reason, the imaging optical system OS of the present invention cannot be constituted so that the system OS extends to one direction like straight type optical systems (coaxial optical systems). That is to say, the imaging optical system of the present invention can be smaller and thinner than the straight type optical systems by bending an optical path.

Since the light ray reaches the image surface while it is being refracted and reflected, the optical path in the imaging optical system OS becomes comparatively long. When the length of the optical path becomes long, the imaging optical system OS can effectively correct and suppress various aberrations using the long optical path. Further, in such an imaging optical system OS, even if a manufacturing error occurs on the prism elements or the like, a change in the performance caused by-the manufacturing error can be suppressed to be small due to the comparatively long optical path.

In the imaging optical system OS of the present invention, at least one of the prisms PR1 to PR3 has the positive power (the prisms PR2 and PR3 in the first embodiment, the prism PR2 in the second embodiment, the prisms PR1, PR2 and PR3 in the third embodiment, and the prisms PR2 and PR3 in the fourth embodiment have the positive power).

The power is an average power in the horizontal direction (called as the direction x for convenience) and in the vertical direction (similarly called as the direction y) {namely, the average of the powers in the directions (horizontal direction and the vertical direction) orthogonal to each other}. The prism element having the positive power (positive prism element) has the positive power in both the horizontal and vertical directions. The positive prism element provides the positive power not only on its one optical working surface but via a plurality of optical working surfaces on one prism element. As a result, the prism element provides the positive power (synthesized positive power).

For example, in the case of a design such that the positive power is provided only by one optical working surface of the prism element, the optical working surface requires a stronger positive power than one of the optical working surfaces of the prism element for providing the synthesized positive power via the plural optical working surfaces. For this reason, comparatively various aberrations easily occur due to the optical working surface which provides the strong positive power. Particularly, spherical aberration becomes large or a tilt of the image surface or the like occurs notably.

In the imaging optical system OS of the present invention, however, the light ray passes through the plural optical working surfaces in one prism element so as to be converged. For this reason, in the present invention, the positive power is dispersed to be imposed on the plural surfaces, and thus the power on the respective optical working surfaces is weakened. As a result, in the entire imaging optical system OS of the present invention, the occurrence of aberrations can be reduced. In the case where the synthesized power of all the prism elements is positive, even when the optical working surfaces for a negative power are provided to those prism elements, the aberrations can cancel each other, so that the occurrence of aberrations in the entire system can be suppressed.

In the imaging optical system OS of the present invention, the emission surface of one prism element in the prisms PR1 to PR3 is arranged so as to be opposed to the incident surface of at least one of the residual prism elements (in the first and second embodiments, the fifth surface s5 is opposed to the sixth surface s6, and the eighth surface s8 is opposed to the ninth surface s9. In the third embodiment, the fifth surface s5 is opposed to the sixth surface s6, and the ninth surface s9 is opposed to the tenth surface s10. In the fourth embodiment, the fourth surface s4 is opposed to the fifth surface s5, and the seventh surface s7 is opposed to the eighth surface s8). With such opposed arrangements, the adjacent prism elements (eventually, the entire imaging optical system) can be housed compactly, and when the opposed surfaces are parallel with each other, the imaging optical system OS where both the surfaces are very close to each other is realized. As a result, the size and the housing space of the imaging optical system OS according to the present invention can be reduced and made to be compact.

Further, in the imaging optical system OS of the present invention, the incident surface where the light ray enters may reflect the light ray reflected by the reflection surface to the emission surface. When the light ray is folded by the reflection surface, the optical path in the prism elements can be compact. The optical surface fulfills both the transmitting and reflecting functions, so that the aberration can be corrected effectively by a small number of the optical surfaces.

In the present invention which maintains the above constitution, the imaging optical system OS is constituted so that intermediate imaging is not performed.

The imaging optical system OS of the present invention refracts and reflects the light ray from the object so as to lead it to the image surface. Depending on the constitution, when a desired focal distance is tried to be obtained in the case where the optical length is very longer than the focal distance in the imaging optical system OS, in general, the light ray is once imaged in the middle portion from the object to the image surface, and the formed image should be relayed. In such a case, a field curvature is likely to be large due to an influence of the positive power required for the relay. Due to the field curvature, the point of focus is different between the center position and the peripheral position of the plane imaging surface. The difference in the point of focus causes a serious deterioration in the performance of the imaging optical system OS.

The optical working surface having a strong negative power is occasionally required in order to correct the field curvature. In this case, major coma aberration occurs due to the optical working surface having negative power. For this reason, the imaging optical system cannot be provided with high performance.

In the imaging optical system which forms an intermediate image, since the influence of an error due to processing is amplified by relay, the control of accuracy becomes tight after all, and thus the practical application becomes difficult. Due to the above reasons, in order to realize the high-performance imaging optical system which is easily made to be practical, it is desirable that the intermediate imaging is not performed on the optical path in the imaging optical system.

There are various methods of preventing the intermediate image from being formed on the optical path (between the object side and the image side). For example, there are the method of providing the optical diaphragm ST onto the optical path and the method of suitably setting the number of the prism elements so as to shorten the length of the optical path like the imaging optical system OS of the present invention. In the imaging optical system OS of the present invention, therefore, the method of performing imaging only on the image surface without forming an intermediate image is not particularly limited.

In the imaging optical system OS of the present invention, however, at least one of the prisms PR1 to PR3 has the positive power. In the case where the prism element having the positive power is provided, it is necessary to make the distribution of the positive power (power distribution) in the imaging optical system OS (the entire system) suitable.

For example, when the prism element having the positive power is present in the imaging optical system OS, an under field curvature occurs due to the positive power. In order to correct such a field curvature, a negative power (the optical working surface having negative power) which copes with the positive power is required in the imaging optical system OS.

When the positive power is not suitable, namely, for example, too strong, the positive power should be strengthened according to the strength of the positive power. Since the entire system requires the positive power, however, the negative optical working surface is arranged near the diaphragm where the height of a light ray is low. In this case, major coma aberration occurs due to the optical working surface with comparatively strong negative power, and thus the imaging performance of the imaging optical system is deteriorated notably. Since asymmetrical astigmatism which is caused by an asymmetrical imaging optical system occurs notably, the imaging performance of the imaging optical system is further deteriorated. Due to such circumstances, it is the requirement of the high-performance imaging optical system that the positive power of the prism element is suitably set. It is, therefore, desirable that the following conditional expression (1) is fulfilled:
0.01<φp/ALL<10.0 (1)
φp: the power of the prism (positive prism) having the positive power
φALL: the power of the entire system.

The conditional expression (1) defines the power of the prism element (positive prism element) having positive power. The conditional expression (1) defines the range for realizing thinning and high performance of the imaging optical system based on the positive power of the prism element.

Concretely, when the power is larger than the upper limit value of the conditional expression (1), the power of the positive prism power becomes too strong, thereby causing coma aberration and astigmatism. For this reason, the performance of the imaging optical system is deteriorated. On the other hand, when the power is smaller than the lower limit value of the conditional expression (1), the power of the positive prism element becomes too weak, thereby reducing contribution of the power of the positive prism element to the entire system. For this reason, it is difficult to thin the imaging optical system. Within the range of the conditional expression (1), therefore, the present invention provides the compact imaging optical system where the occurrence of aberration is restricted.

Since the imaging optical system OS of the present invention is the asymmetrical optical system, asymmetry-specific aberration such as asymmetrical astigmatism also occurs. That is to say, the present invention has a constitution where various aberrations is likely to occur in comparison to the straight-type optical systems. From this viewpoint, it is the requirement of the high-performance imaging optical system OS to design the positive prism element within the range of the conditional expression (1). As to the conditional range defied by the conditional expression, it is more desirable that the range of the following conditional expression (2) is fulfilled.
0.05<φP/φALL<0.3 (2)

Results that the embodiments are made to correspond to the conditional expression (1) are as follows.
Embodiment 1: φp/φALL of the prism PR2=0.59
   φp/φALL of the prism PR3=0.79
Embodiment 2: φp/φALL of the prism PR2=1.01
Embodiment 3: φp/φALL of the prism PR1=0.33
   φp/φALL of the prism PR2=0.27
   φp/φALL of the prism PR3=1.18
Embodiment 4: φp/φALL of the prism PR2=0.38
   φp/φALL of the prism PR3=0.72

The shape of the prisms PR1 to PR3 to be used in the imaging optical system OS of the present invention is not particularly limited. The prism elements having the simple structure (less number of the optical working surfaces) can greatly contribute to miniaturization of the imaging optical system OS. This is because in the case of the constitution where a light ray reflects many times in the prism element, the number of the reflection surfaces is excessive, thereby increasing the size of the prism element.

The imaging optical system OS of the present invention is preferably constituted so that at least one of the prisms PR1 to PR3 has three surfaces including: one incident surface where a light ray enters; one reflection surface which reflects the light ray from the incident surface; and one emission surface which allows the light ray from the reflection surface to emit therefrom (in the first, second and third embodiments, the prisms PR2 and PR3 have the three surfaces, and in the fourth embodiments, the prisms PR1, PR2 and PR3 have the three surfaces).

Even in the case where at least one of the prisms PR1 to PR3 has one incident surface, at least two reflection surfaces and one emission surface, this constitution can occasionally contribute to the miniaturization of the imaging optical system OS sufficiently.

Such prism element having the simple constitution has the small size, thereby miniaturizing the imaging optical system OS. Due to the simple constitution, the prism element can be manufactured easily, and thus the imaging optical system OS which is advantageous to processing and cost is realized. Further, occurrence of an error at the time of the manufacturing can be suppressed. The present invention, therefore, provides the imaging optical system where occurrence of aberrations due to the manufacturing error is suppressed (the manufacturing error-resistant imaging optical system OS).

In the imaging optical system OS including such prism elements, another prism elements can be arranged on the basis of the simple prism element. For this reason, the arrangement accuracy of the prism elements (position accuracy) is improved. Further, various performances can be evaluated based on the simple prism element.

The imaging optical system OS of the present invention is the asymmetrical optical system. The optical working surfaces which are asymmetrically arranged so as to compose the asymmetrical optical system, however, are not particularly limited. For example, any of the incident surface, the reflection surface and the emission surface of the prism element may be asymmetrically arranged. At the time of reflection, a light ray is necessarily bent. For this reason, it is desirable that the reflection surface of the prism element is asymmetrically arranged. As a result, the asymmetrical arrangement is combined with the reflection of the light ray, so that the light ray is bent at various angles. For this reason, the size of the prism elements, and finally the size of the imaging optical system OS becomes small, and a three-dimensional arrangement becomes possible.

In the asymmetrical imaging optical system OS of the present invention, asymmetry-specific aberration occurs. In order to correct such an aberration effectively, it is desirable that the imaging optical system OS includes an asymmetrical surface. For example, at least one of the incident surface, the reflection surface and the emission surface may be the asymmetrical surface.

In order to correct the aberrations effectively, at least one surface may be a free-form surface on the optical working surface on the prisms PR1 to PR3. This is because, for example, a free-form surface, where shapes of the optical working surface in the horizontal direction and the vertical direction are different, can effectively correct astigmatism or the like on the axis caused by the asymmetrical optical system.

The embodiment refers to the imaging optical system OS including only the three prisms PR1 to PR3 (image taking apparatus ITA) as an example. The imaging optical system OS of the present invention is not, however, limited to this. For example, in the imaging optical system OS, at least another small-sized optical element (for example, a lens or a reflection mirror) may be added to the three prism elements, or three or more (for example, four) prism elements may be provided.

Even with such a constitution, the above-mentioned effect of the present invention is sufficiently produced. The excessive number of the prism elements might cause enlargement of the imaging optical system OS. From this viewpoint, it can be said that the imaging optical system OS including of the three prisms PR1 to PR3 is preferable.

The material of the prism elements included in the imaging optical system OS of the present invention is not particularly limited. That is to say, the material of the prism element may be glass or resin (plastic material or the like), and may be any material which can be used as an optical material. Materials preferably have less dependence liability of temperature (heat) or the like. In the case where the resin material is used for the prism element, the imaging optical system OS of the present invention uses resin (athermal resin) whose temperature dependency is low. More specifically, the prism element includes athermal resin which has comparatively less optical transition such as a change in refractive index and a change in Abbe number due to temperature. The athermal resin may be included in the prism element partially or entirely. Athermal resins having different properties may be mixed. This provides an effect such that the changes due to temperature cancel each other.

When such resin materials with less change in refractive index are included in the prism elements, a change in the image point position due to the change in the refractive index based on the temperature change is suppressed in the imaging optical system OS. The imaging optical system OS of the present invention has the asymmetrical optical working surfaces. For this reason, the astigmatic difference or the like easily occurs on the axis. The prism elements composed of the resin (athermal resin) whose change in the refractive index is suppressed can suppress the astigmatic difference or the like effectively.

An example of such an athermal resin is such that particles whose maximum length is 30 nm or less [sub material; for example, niobium oxide (Nb2O5)] are dispersed in resin (base material) (see Japanese Patent Application Laid-Open No. 2005-55852). In such a resin (mixed resin), lowering of the refractive index due to a rise in temperature and rise in the refractive index of the particles due to rise in temperature occur simultaneously. For this reason, both the temperature dependencies (the lowering of refractive index and the rise in refractive index) are offset by each other, and thus the change in refractive index difficultly occurs.

The offset between the lowering of refractive index due to the temperature dependency and the rise in refractive index due to the temperature dependency is explained in detail by giving an example. The change in refractive index depending on the temperature is expressed by the following equation of refractive index and change in temperature by differentiating the refractive index nd with respect to the temperature t based on the Lorentz equation:

$$A = \frac{( {nd}^{2} + 2 ) \cdot ( {nd}^{2} - 1 )}{6 nd} \cdot \{ ( - 3 α ) + \frac{1}{[ R ]} \cdot \frac{\partial [ R ]}{\partial t} \} \qquad [ Equation 3 ]$$

where
α: linear coefficient of expansion
[R]: molecular refraction

When a value of the equation of refractive index and change in temperature in some resins (base material) and inorganic fine particles (sub-material) (temperature change A=dnd/dt) is obtained, the results are as shown in the following tables 17 and 18 (unit: [/°C.]).

TABLE 17

| Resin | A × 10⁻⁵ [/° C.] |
|---|---|
| Poleolefin | −11 |
| Polycarbonate | −14 |

TABLE 18

| Inorganic fine particle | A × 10⁻⁵ [/° C.] |
|---|---|
| Aluminum oxide | 1.4 |
| ALON (nitride oxide) | 1.2 |
| Beryllium oxide | 1.0 |
| Diamond | 1.0 |
| Calcium Carbonate | 0.7 |
| Titan-kalium phosphate | 1.2 |
| Magnesium aluminate | 0.9 |
| Magnesium oxide | 1.9 |
| Quartz | 1.2 |
| Tellurium oxide | 0.9 |
| Yttrium oxide | 0.8 |
| Zinc oxide | 4.9 |

The prism elements of the imaging optical system OS in the present invention is not limited to the mixed material where niobium oxide is dispersed, and may be composed of a mixed material where inorganic fine particles in Table 18 are dispersed in the resin in Table 17 (for example, the mixed material where aluminum oxide is dispersed in olefin resin).

As a result, the resin with symbol A (−) and the inorganic fine particles with symbol A (+) are present in the mixed material (mixed resin). That is to say, the resin and the inorganic fine particles with opposite symbols are mixed. It is, therefore, found that the lowering of refractive index of the resin caused by the temperature rise (first property) and the rise in refractive index of the inorganic fine particles due to the temperature rise (second property) are canceled each other effectively in the prism element. Particularly due to the cancellation, even when a ratio of the inorganic fine particles to the resin is small, the change in refractive index of the prism element is suppressed sufficiently.

In the mixed material (mixed resin), a mixing ratio of the resin with symbol A (−) to the inorganic fine particles with symbol A (+) is variously adjusted. For this reason, the mixed resin has the symbol A (+) differently from a resin with symbol A (−) and a mixed resin with symbol A (−). When such a resin material is used partially for the optical system, the influence due to the temperature change in the individual optical elements can be cancelled in the entire system. In this case, a movement of the image point and an increase in the astigmatic difference due to the temperature change in the entire optical system can be reduced.

A dispersion amount or the like of the inorganic fine particles with respect to the resin (base material) is adjusted suitably. As a result, the property of the athermal resin newly changes. As one example of the change in the property, when the inorganic fine particles (sub-material) are mixed, the linear coefficient of expansion in the resin material (base material), namely, the athermal resin becomes comparatively small. The method of providing the property such that the above change in property and a change in refractive index due to the temperature dependency are reduced is not limited to the adjustment of the dispersion amount. For example, inorganic fine particles where absolute value of “A” (symbol A (+)) is comparatively large may be dispersed in the resin material. Another material with such “A” property (organic fine particles or the like) may be dispersed.

Even when the resin and the inorganic fine particles have the same symbol A, the change in refractive index of the prism elements due to the temperature change can be reduced. For example, in the case of inorganic fine particles whose absolute value of A is smaller than that of the resin, the change in refractive index of the mixed resin including the inorganic fine particles becomes smaller than the refractive index of independent resin. That is to say, when the mixed resin includes inorganic particles, the change in refractive index depending on the temperature change can be smaller than that of the independent resin. When the inorganic fine particles having different symbol A from that of the resin are dispersed, the dispersion amount can be reduced further than the case where the inorganic fine particles having the same symbol A as that of the resin are dispersed.

The present invention is not limited to the above embodiments, and various changes can be made without departing from the gist of the present invention.

For example, it is preferable that all the reflection surfaces included in the imaging optical system OS have reflectance of 80% or more. The reflectance of the imaging optical system (entire system) OS is obtained by multiplication on the respective reflectance surfaces. In other words, in order to improve the reflectance of the imaging optical system OS, at least one of the reflection surfaces may have the reflectance of 80% or more. This is because when one surface which has the reflectance of 80% or more greatly contributes to an improvement in the reflectance of the imaging optical system OS.

The reflection surfaces of the prism elements may include reflection areas and absorption areas, or include reflection areas and light shielding areas. The reflection surfaces of the prism elements may include reflection areas and transmission areas. That is to say, the reflection surfaces of the prism elements may include reflection areas and non-reflection areas (absorption areas, light shielding areas, transmission areas or the like).

With such a constitution, the non-reflection areas of the reflection surfaces can be made to correspond to the positions of edges on the reflection surfaces. As a result, stray light due to the reflection on the edges cannot be generated. Further, the non-reflection areas of the reflection surfaces can be served as holding portions for attaching the prism elements to imaging devices or the like.

The reflection areas on the reflection surfaces may have various properties. For example, the reflection areas may be mirror planes. With such a constitution, concavity and convexity or ripple are not present on the reflection areas. For this reason, the reflecting efficiency is improved without generating stray light due to the ripple or the like on the reflection areas.

The reflection surfaces are subject to reflection coating or the like, so that the reflection areas may be formed. With such a constitution, only desired positions can be served as the reflection areas. For example, only a portion corresponding to an effective diameter (effective range) such as the optical diaphragm ST can be the reflection areas.

Examples of the reflecting coating for the reflection areas include various coatings. Some types of coatings and their features are explained below.
Aluminum deposition coating
   This coating provides comparatively high reflectance and is comparatively inexpensive.
Aluminum reflection-increasing coating
   This coating is comparatively expensive but provides higher reflectance than that of the aluminum deposition coating.
Dielectric coating and silver deposition coating
   Both coatings are comparatively expensive but provides notably high reflectance. For this reason, even when the reflection of a light ray is repeated a plural number of times, loss of light quantity is suppressed.

When all the reflection surfaces of the prism elements include the aluminum deposition coating surfaces, the cost for forming the reflection surfaces is suppressed, and finally the cost of the prism elements is suppressed. The total reflectance of the prism elements is, however, lower than the reflectance of the prism elements include another coating surfaces (dielectric coating surfaces or the like). On the contrary, in the case where all the reflection surfaces of the prism elements include the dielectric coating surfaces, the total reflectance of the prism elements becomes high due to very high reflectance. Due to the expensive coating, however, the cost of the prism elements rises.

In the imaging optical system OS of the present invention, the coating reflection surfaces (the aluminum deposition coating surface, the aluminum reflection-increasing coating surface, the dielectric coating surface and the silver deposition coating surface) may be present in a mixed manner as the reflection surfaces of the prism elements. With such a constitution (for example, plural types are selected from four types of the surfaces), the prism elements where the cost is suppressed and simultaneously the reflectance is improved is realized.

The non-reflection areas on the reflection surfaces (particularly, the absorption areas and light shielding areas) may have various properties. For example, the non-reflection areas may be formed by rough grinding. The rough grinding utilizes, for example, curve generator. For this reason, a desired area on the reflection surface is shaped into the non-reflection area comparatively easily. The cost of the rough grinding is inexpensive.

The non-reflection area may be formed by surface roughing. The surface roughing is carried out, for example, by a molding press. Concretely, the surface roughing is carried out by pressing where the mold is partially roughed. For this reason, a desired area on the reflection surface is shaped into the non-reflection area comparatively easily and inexpensively. The surface roughing may be carried out by rough grinding (for example, grinding without abrading agent; grinding without finish).

The above methods (rough grinding, surface roughing) unlevel the surfaces so as to form the non-reflection areas. In the case where such methods are used, the non-reflection areas where fine pieces lifted up from the reflection surfaces (lifted-up pieces; for example, square pyramid) disperse may be formed. That is to say, the non-reflection areas having a plurality of lifted-up pieces for scattering a light ray may be formed.

In such non-reflection areas, since a light ray is attenuated near the lifted-up pieces, stray light can be suppressed. The method of forming the non-reflection areas including the lifted-up pieces is not limited to the above methods (rough grinding and surface roughing). When the non-reflection areas including the lifted-up pieces are formed by an inexpensive molding press or the like, the prism elements can be incorporated into the imaging optical system OS without providing an individual member for straight light.

The non-reflection areas are constituted so that eminences such as convex or concave are provided on the reflection surfaces. The non-reflection areas are, however, not limited to this type. For example, the reflection surface is partially finished with black oxide, so that the non-reflection area is formed. In this case, deformation or the like does not occur on the non-reflection area. For this reason, the non-reflection areas can be served as a prism element attaching position reference.

The non-reflection area may be formed by a chemical reaction using an organic solvent. In the case of the chemical reaction, a plurality of reflection surfaces can be simultaneously soaked in an organic solvent, or an organic solvent can be applied simultaneously to a plurality of reflection surfaces. For this reason, large-scale process (production) can be performed at one time. Further, in the case where the non-reflection areas are formed by changing the property of the prism element material, the surfaces of the non-reflection areas are not deformed similarly to the above description. In this case, therefore, the similar effect to that of the non-reflection areas formed by black oxide finish can be produced.

In the imaging optical system OS (image taking apparatus ITA) of the present invention, light ray with various wavelength bands enter. These light rays include unnecessary light rays (for example, infrared rays) from the viewpoint that the light rays are imaged. Imaging devices SR such as CCD have sensitivity with respect to the wavelength band (long wavelength range) of the infrared ray. For this reason, a bad influence is occasionally exercised on a light receiving surface (imaging surface) of the imaging devices SR due to the infrared ray.

In the present invention, therefore, any one of the surfaces (the transmission surface and the reflection surface) of the prism elements may be subject to coating for absorbing a light ray with long wavelength range. With such a constitution, for example, a plane parallel plate or the like which is served as an IR cut filter does not have to be arranged before the imaging devices SR. As a result, the high-performance (for example, high resolution is provided) imaging optical system OS whose cost is suppressed is realized.

The shape of the optical diaphragm ST is not particularly limited. For example, the shape may be circular or oval. Further, the optical diaphragm may have a polygonal shape or an asymmetrical shape.

Although the present invention has been fully described by way of examples with reference to the accompanying drawings, it is to be noted that various changes and modifications will be apparent to those skilled in the art. Therefore, unless such changes and modification depart from the scope of the present invention, they should be construed as being included therein.

What is claimed is:

1. An imaging optical system comprising:
a plurality of prism elements through which a light ray advancing from an object to an imaging device passes, wherein
at least one of the prism elements has an asymmetrical optical surface;
at least one prism element has a positive power;
an emission surface of one of the prism elements and an incident surface of at least one of the residual prism elements are arranged so as to be opposed to each other;
the number of the prism elements is more than three; and the light ray which passes through the prism elements is not intermediately imaged.

2. The imaging optical system of claim 1, wherein the prism element having the positive power fulfills the following conditional expression (1)
0.01<φp/φALL<10.0 (1)
φp: the power of the prism element having the positive power
φALL: the power of the entire imaging optical system.

3. The imaging optical system of claim 2, wherein at least one of the prism elements have three surfaces including one incident surface for allowing the light ray to enter, one reflection surface for reflecting the light ray from the incident surface and one emission surface for allowing the light ray from the reflection surface to emit as the optical surfaces.

4. The imaging optical system of claim 2, wherein at least one of the prism elements has one incident surface for allowing the light ray to enter, at least two reflection surfaces for reflecting the light ray from the incident surface and one emission surface for allowing the light ray from the reflection surfaces to emit as the optical surfaces.

5. The imaging optical system of claim 3, wherein at least one of the prism elements has the incident surface for allowing the light ray to enter, and the incident surface reflects the light ray reflected by the reflection surface to the emission surface.

6. The imaging optical system of claim 3, wherein at least one of the optical surfaces of the prism elements is asymmetrical surface.

7. The imaging optical system of claim 3, wherein at least one of the optical surfaces of the prism elements is free-form surface.

8. The imaging optical system of claim 3, wherein the number of the prism elements is three.

9. The imaging optical system of claim 3, wherein at least one of the prism elements is formed by resin whose optical transition depending on the temperature is small.

10. The imaging optical system of claim 9, wherein the resin includes a base material and a sub-material, wherein the first property of the base material changes by the second property of the sub-material.

11. The imaging optical system of claim 9, wherein the optical transition depending on the temperature is refractive index of the resin.

12. An image taking apparatus comprising:
an imaging device; and
a plurality of prism elements through which a light ray advancing from an object to the imaging device passes wherein
at least one of the prism elements has an asymmetrical optical surface,
at least one prism element has a positive power,
an emission surface of one of the prism elements and an incident surface of at least one of the residual prism elements are arranged so as to be opposed to each other,
the number of the prism elements is more than three,
the light ray which passes through the prism elements is not intermediately imaged,
at least one of the prism elements has three surfaces including one incident surface for allowing the light ray to enter, one reflection surface for reflecting the light ray from the incident surface and one emission surface for allowing the light ray from the reflection surface to emit as the optical surfaces, and
the prism element having the positive power fulfills the following conditional expression (1)
0.01<φp/φALL<10.0 (1)
φp: the power of the prism element having the positive power
φALL: the power of the entire imaging optical system.

13. An image optical system comprising:
a plurality of prism elements through which a light ray advancing from an object to an imaging device passes, wherein
at least one of the prism elements has three surfaces including one incident surface for allowing the light ray to enter, one asymmetrical reflection surface for reflecting the light ray from the incident surface and one emission surface for allowing the light ray from the reflection surface to emit as the optical surfaces,
an emission surface of one of the prism elements and an incident surface of at least one of the residual prism elements are arranged so as to be opposed to each other,
the number of the prism elements is more than three,
the light ray which passes through the prism elements is not intermediately imaged,
at least one prism element has a positive power, and
the prism element having the positive power fulfills the following conditional expression (1)
0.01<φp/φALL<10.0 (1)
φp: the power of the prism element having the positive power
φALL: the power of the entire imaging optical system.

14. The imaging optical system of claim 13, wherein at least one of the prism elements has the incident surface where the light ray enters reflect the light ray reflected by the reflection surface to the emission surface.

15. The imaging optical system of claim 13, wherein at least one of the optical surfaces of the prism elements is asymmetrical surface.

16. The imaging optical system of claim 13, wherein at least one of the optical surfaces of the prism elements is free-form surface.

17. The imaging optical system of claim 13, wherein the number of the prism element is three.

18. The imaging optical system of claim 13, wherein at least one of the prism elements is formed by resin whose refractive index depending on the temperature is small.

19. An image taking apparatus comprising:
an imaging device; and
a plurality of prism elements through which a light ray advancing from an object to the imaging device passes, wherein
at least one of the prism elements has three surfaces including one incident surface for allowing the light ray to enter, one asymmetrical reflection surface for reflecting the light ray from the incident surface and one emission surface for allowing the light ray from the reflection surface to emit as the optical surfaces,
an emission surface of one of the prism elements and an incident surface of at least one of the residual prism elements are arranged so as to be opposed to each other,
the number of the prism elements is more than three,
the light ray which passes through the prism elements is not intermediately imaged,
at least one prism element has a positive power, and
prism element having the positive power fulfills the following conditional expression (1)
0.01<φp/φALL<10.0 (1)
φp: the power of the prism element having the positive power
φALL: the power of the entire imaging optical system.

20. The image taking lens unit of claim 19, wherein at least one of the prism elements is formed by resin whose refractive index depending on the temperature is small.
